(19) United States
(12) Patent Application Publication
(10) Pub. No.: US 2024/0345576 A1
(43) Pub. Date: Oct. 17, 2024

(54) CONTROL DEVICE AND METHOD FOR CONTROLLING AUTONOMOUS DRIVING DEVICE THEREOF

(71) Applicants: Hyundai Motor Company, Seoul (KR); Kia Corporation, Seoul (KR)

(72) Inventors: Ga Hee Kim, Seoul (KR); Yun Sub Kim, Suwon-Si (KR); Hwan Hee Lee, Gunpo-Si (KR); Seung Yong Lee, Uiwang-Si (KR)

(21) Appl. No.: 18/388,980

(22) Filed: Nov. 13, 2023

(30) Foreign Application Priority Data
Apr. 13, 2023 (KR) 10-2023-0048903

(51) Int. Cl. G05D 1/00; G05D 1/02

(52) U.S. Cl. CPC G05D 1/0027

(57) ABSTRACT

A control device and a method for controlling an autonomous driving device thereof are provided. The control device includes a communication device, a processor, and storage. The processor receives a driving path request from a first external autonomous driving device, receives information associated with a second external autonomous driving device and information associated with a passage, determines a driving path of the first external autonomous driving device and a driving path of the second external autonomous driving device, provides the first external autonomous driving device and the second external autonomous driving device with the determined driving paths, transmits a control request for allowing the second external autonomous driving device to drive along the determined driving path to an external control device, receives a response to the control request, and provides the first external autonomous driving device with the determined driving path or a corrected driving path.

### CROSS-REFERENCE TO RELATED APPLICATION

This application claims the benefit of priority to Korean Patent Application No. 10-2023-0048903, filed in the Korean Intellectual Property Office on Apr. 13, 2023, the entire contents of which are incorporated herein by reference.

### TECHNICAL FIELD

The present disclosure relates to a control device and a method for controlling an autonomous driving device, and more particularly, relates to technologies of determining a driving path of the autonomous driving device and controlling driving of the autonomous driving device in the control device.

### BACKGROUND

An autonomous driving device (e.g., an autonomous mobile robot) may include a device which is capable of searching its surroundings, detecting obstacles, and selecting a path using its wheels or legs to reach a destination. As an example, the autonomous driving device may move to a specified destination in a specified place (e.g., a specific building or a specific place) and provide various services (e.g., a delivery service). The autonomous driving device may determine a path for moving to the destination based on information about the specified place and may move to the destination along the determined path to provide a service.

The autonomous driving device may be managed by a control device (e.g., a control server). For example, the autonomous driving device may be controlled in operation and driving by a manager (e.g., a manager device) by means of the control device.

However, when a plurality of autonomous driving devices drive in the same place, there may be a situation where the plurality of autonomous driving devices become obstacles to each other because movement paths (or driving paths) thereof overlap with each other while driving or should perform cross paths with each other on a narrow passage.

### SUMMARY

The following summary presents a simplified summary of certain features. The summary is not an extensive overview and is not intended to identify key or critical elements.

An aspect of the present disclosure provides a control device for determining a driving path for avoiding an obstacle to reach a destination depending on a driving situation of an autonomous driving device and providing the autonomous driving device with the driving path and a method for controlling an autonomous driving device.

Another aspect of the present disclosure provides a control device for controlling cross driving of a plurality of autonomous driving devices in conjunction with an external control server and a method for controlling an autonomous driving device.

Another aspect of the present disclosure provides a control device for controlling external structures which are present on a driving path of an external autonomous driving device for driving of the external autonomous driving device and a method for controlling an autonomous driving device.

The technical problems to be solved by the present disclosure are not limited to the aforementioned problems, and any other technical problems not mentioned herein will be clearly understood from the following description by those skilled in the art to which the present disclosure pertains.

A control device may comprise: a communication device; a processor; and storage storing information about a plurality of autonomous driving devices and a cross-driving rule associated with the plurality of autonomous driving devices, wherein the processor is configured to: receive, via the communication device, a driving path request from a first external autonomous driving device associated with the control device; receive, from the first external autonomous driving device via the communication device, information associated with a second external autonomous driving device and information associated with a passage on which the first external autonomous driving device meets with the second external autonomous driving device; determine a driving path of the first external autonomous driving device and a driving path of the second external autonomous driving device based on: at least a portion of the information about the plurality of autonomous driving devices, the information associated with the second external autonomous driving device, the information associated with the passage, or the cross-driving rule; based on a determination that the second external autonomous driving device is associated with the control device, transmit, to each of the first external autonomous driving device and the second external autonomous driving device, the determined driving paths via the communication device; and based on a determination that the second external autonomous driving device is associated with an external control device: transmit, to the external control device via the communication device, a control request for allowing the second external autonomous driving device to drive along the determined driving path of the second external autonomous driving device; receive, from the external control device via the communication device, a response to the control request; and transmit, to the first external autonomous driving device and based on the response to the control request, the determined driving path of the first external autonomous driving device or a corrected driving path via the communication device.

The information about the plurality of autonomous driving devices may comprise at least one of: identification information of each of the plurality of autonomous driving devices, manufacturer information of each of the plurality of autonomous driving devices, size information of each of the plurality of autonomous driving devices, information about a sensor configuration included in each of the plurality of autonomous driving devices, or information about a margin of a predetermined sensor.

The cross-driving rule may comprise: a criterion for determining, based on the information about the passage and the information about the plurality of autonomous driving devices, an autonomous driving device to drive along the passage and an autonomous driving device to move to an edge of the passage.

The processor may be configured to: based on the response indicating that it is able to control the second external autonomous driving device to drive along the determined driving path of the second external autonomous driving device, transmit, to the first external autonomous driving device, the determined driving path of the first external autonomous driving device.

The processor may be configured to: based on the response indicating that it is unable to control the second external autonomous driving device to drive along the determined driving path of the second external autonomous driving device: change the driving path of the first external autonomous driving device such that the first external autonomous driving device is able to avoid a collision with the second external autonomous driving device and move to a destination; and transmit, to the first external autonomous driving device, the corrected driving path.

The processor may be configured to: based on a determination that the first external autonomous driving device is unable to avoid a collision with the second external autonomous driving device to reach the destination, transmit, to the first external autonomous driving device or an external manager device associated with the control device, a notification indicating that a safe driving route is unavailable.

The processor may be configured to: determine whether there is a need to manipulate an external facility device, for using the determined driving path of the first external autonomous driving device, call an application programming interface (API) for controlling the external facility device, based on a determination that there is the need to manipulate the external facility device, receive an API call result from the external facility device, and determine the corrected driving path based on the API call result.

The processor may be configured to: determine whether a width of the passage satisfies a reference width where it is possible for the first external autonomous driving device to cross paths with the second external autonomous driving device, based on the information about the plurality of autonomous driving devices and the information associated with the passage; and based on the width of the passage not satisfying the reference width, transmit, to the first external autonomous driving device, a command to decrease a sensor margin of the first external autonomous driving device to a specified rate.

The processor may be configured to: based on the width of the passage not satisfying the reference width, transmit, to the first external autonomous driving device, a command to decrease a driving speed of the first external autonomous driving device.

The processor may be configured to: receive, from the first external autonomous driving device and the second external autonomous driving device, information about autonomous driving results via the communication device; and update, based on the received information about autonomous driving results, the cross-driving rule.

A method performed by a control device may comprise: receiving a driving path request from a first external autonomous driving device associated with the control device; receiving, from the first external autonomous driving device, information associated with a second external autonomous driving device and information associated with a passage on which the first external autonomous driving device meets with the second external autonomous driving device; determining a driving path of the first external autonomous driving device and a driving path of the second external autonomous driving device based on: at least a portion of information about a plurality of autonomous driving devices, the information associated with the second external autonomous driving device, the information associated with the passage, or a cross-driving rule; and based on a determination that the second external autonomous driving device is associated with an external control device: transmitting, to the external control device, a control request for allowing the second external autonomous driving device to drive along the determined driving path of the second external autonomous driving device; receiving, from the external control device, a response to the control request; and transmitting, to the first external autonomous driving device and based on the response to the control request, the determined driving path of the first external autonomous driving device or a corrected driving path.

The information about the plurality of autonomous driving devices may comprise at least one of: identification information of each of the plurality of autonomous driving devices, manufacturer information of each of the plurality of autonomous driving devices, size information of each of the plurality of autonomous driving devices, information about a sensor configuration included in each of the plurality of autonomous driving devices, or information about a margin of a predetermined sensor.

The cross-driving rule may comprise: a criterion for determining, based on the information about the passage and the information about the plurality of autonomous driving devices, an autonomous driving device to drive along the passage and an autonomous driving device to move to an edge of the passage.

The transmitting the determined driving path of the first external autonomous driving device or the corrected driving path may comprise: based on the response indicating that it is able to control the second external autonomous driving device to drive along the determined driving path of the second external autonomous driving device, transmitting, to the first external autonomous driving device, the determined driving path of the first external autonomous driving device.

The transmitting the determined driving path of the first external autonomous driving device or the corrected driving path may comprise: based on the response indicating that it is unable to control the second external autonomous driving device to drive along the determined driving path of the second external autonomous driving device: changing the driving path of the first external autonomous driving device such that the first external autonomous driving device is able to avoid a collision with the second external autonomous driving device and move to a destination; and transmitting, to the first external autonomous driving device, the corrected driving path.

The method may further comprise: based on a determination that the first external autonomous driving device is unable to avoid a collision with the second external autonomous driving device to reach the destination, transmitting, to the first external autonomous driving device or an external manager device associated with the control device, a notification indicating that a safe driving route is unavailable.

The method may further comprise: determining whether there is a need to manipulate an external facility device, for using the determined driving path of the first external autonomous driving device; calling an application programming interface (API) for controlling the external facility device, based on a determination that there is the need to manipulate the external facility device; receiving an API call result from the external facility device; and determining the corrected driving path based on the API call result.

The method may further comprise: determining whether a width of the passage satisfies a reference width where it is possible for the first external autonomous driving device to cross paths with the second external autonomous driving device, based on the information about the plurality of autonomous driving devices and the information associated with the passage; and based on the width of the passage not satisfying the reference width, transmitting, to the first external autonomous driving device, a command to decrease a sensor margin of the first external autonomous driving device to a specified rate.

The method may further comprise: based on the width of the passage not satisfying the reference width, transmitting, to the first external autonomous driving device, a command to decrease a driving speed of the first external autonomous driving device.

The method may further comprise: receiving, from the first external autonomous driving device and the second external autonomous driving device, information about autonomous driving results; and updating, based on the received information about autonomous driving results, the cross-driving rule.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a configuration of an autonomous driving control system;

FIG. 2 is a block diagram of a control device;

FIG. 3 is a block diagram of a control device;

FIG. 4 is a block diagram of an autonomous driving device;

FIG. 5 is a drawing for describing an operation where a control device controls driving of an autonomous driving device;

FIG. 6 is a drawing for describing an operation where a control device controls driving of an autonomous driving device;

FIG. 7 is a drawing for describing an operation where a control device controls driving of an autonomous driving device;

FIG. 8 is a flowchart of a method for controlling an autonomous driving device in a control device;

FIG. 9 is a flowchart of a method for controlling an autonomous driving device in a control device; and

FIG. 10 is a block diagram illustrating a computing system.

### DETAILED DESCRIPTION

Hereinafter, various features of the present disclosure will be described in detail with reference to the accompanying drawings. In adding the reference numerals to the components of each drawing, it should be noted that the identical component is designated by the identical numerals even when they are displayed on other drawings. Further, in describing the features of the present disclosure, a detailed description of well-known features or functions will be ruled out in order not to unnecessarily obscure the gist of the present disclosure.

In describing the components according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

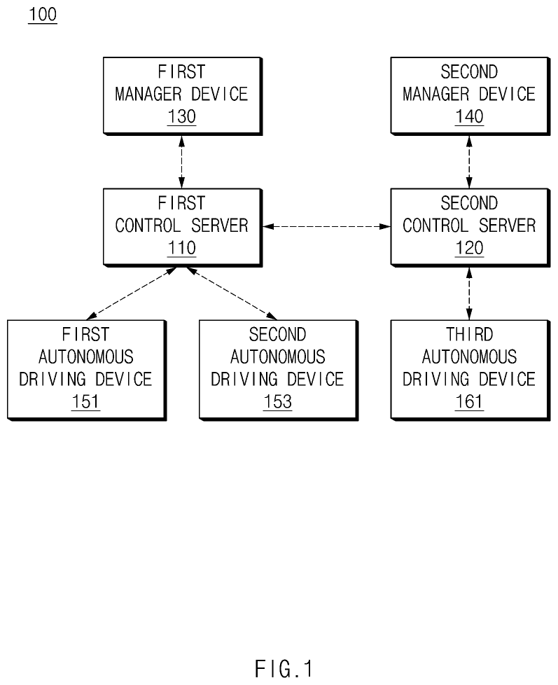

Hereinafter, various examples of the present disclosure will be described in detail with reference to FIGS. 1 to 10.

FIG. 1 is a drawing illustrating a configuration of an autonomous driving control system.

An autonomous driving control system 100 may include at least one control server, at least one manager device, and at least one autonomous driving device.

A first control server 110 may control a first autonomous driving device 151 and a second autonomous driving device 153. For example, the first control server 110 may be associated with a first manufacturer. For example, the first autonomous driving device 151 and the second autonomous driving device 153 manufactured by the first manufacturer may be registered with the first control server 110. For example, each of the first autonomous driving device 151 and the second autonomous driving device 153 may transmit and receive data with the first control server 110 while providing a specified service.

The first control server 110 may store data associated with at least one autonomous driving device (e.g., the first autonomous driving device 151 and the second autonomous driving device 153) associated with the first manufacturer.

The first control server may 110 receive data associated with autonomous driving from the first autonomous driving device 151 and/or the second autonomous driving device 153. For example, the first control server 110 may receive sensor data obtained by the first autonomous driving device 151 and/or the second autonomous driving device 153. For example, the first control server 110 may receive data for another autonomous driving device (e.g., a third autonomous driving device 161), which is detected by the first autonomous driving device 151 and/or the second autonomous driving device 153, from the first autonomous driving device 151 and/or the second autonomous driving device 153. For example, the first control server 110 may receive data associated with a passage on the driving path detected by the first autonomous driving device 151 and/or the second autonomous driving device 153 from the first autonomous driving device 151 and/or the second autonomous driving device 153.

The first control server 110 may request data associated with the third autonomous driving device 161 from the second control server 120. The first control server 110 may determine driving paths of autonomous driving devices based on at least some of data associated with an autonomous driving device (e.g., the first autonomous driving device 151 and/or the second autonomous driving device 153), which is previously stored, data associated with the autonomous driving device (e.g., the third autonomous driving device 161), which is received from the second control server 120, and data associated with the passage and may transmit the determined driving path to the autonomous driving device (e.g., the first autonomous driving device 151 and/or the second autonomous driving device 153). The first autonomous driving device 151 and/or the second autonomous driving device 153 may perform autonomous driving along the driving path received from the first control server 110. For example, when autonomous driving devices registered with the first control server 110 or an autonomous driving device registered with the first control server 110 and an autonomous driving device registered with the second control server 120 meet with each other on the passage, the first control server 110 may determine whether the autonomous driving devices are able to perform cross driving and pass through the passage and may determine a driving path of each of the autonomous driving devices based on the determined result. For example, when it is possible for the autonomous driving devices which run into each other to perform cross driving on the passage, the first control server 110 may provide each of the autonomous driving devices with a driving path for cross driving. When it is impossible for the autonomous driving devices which run into each other to cross paths with each other on the passage, the first control server 110 may navigate a new driving path and may provide each of the autonomous driving devices with a corrected driving path. For example, the first control server 110 may provide the autonomous driving device registered with the second control server 120 with the driving path through the second control server 120.

A first manager device 130 may control an operation of the first autonomous driving device 151 and/or an operation of the second autonomous driving device 153 by means of the first control server 110. For example, the first control server 110 may manually control an operation (e.g., driving, waiting, stop, and/or path seeking) of the first autonomous driving device 151 and/or an operation (e.g., driving, waiting, stop, and/or path seeking) of the second autonomous driving device 153 depending on an input of a manager. The first autonomous driving device 151 and/or the second autonomous driving device 153 may perform an operation according to the control command received from the first control server 110.

The second control server 120 may control the third autonomous driving device 161. For example, the second control server 120 may be associated with a second manufacturer. For example, the third autonomous driving device 161 manufactured by the second manufacturer may be registered with the second control server 120. For example, the third autonomous driving device 161 may transmit and receive data with the second control server 120 while providing a specified service.

The second control server 120 may store data associated with at least one autonomous driving device (e.g., the third autonomous driving device 161) associated with the second manufacturer.

The second control server 120 may receive data associated with autonomous driving from the third autonomous driving device 161. For example, the second control server 120 may receive sensor data obtained by the third autonomous driving device 161. For example, the second control server 120 may receive data for another autonomous driving device (e.g., the first autonomous driving device 151 and/or the second autonomous driving device 153), which is detected by the third autonomous driving device 161, from the third autonomous driving device 161. For example, the second control server 120 may receive data associated with a passage on a driving path detected by the third autonomous driving device 161 from the third autonomous driving device 161.

The second control server 120 may request data associated with the first autonomous driving device 151 and/or the second autonomous driving device 153 from the first control server 110. The first control server 110 may determine driving paths of autonomous driving devices based on at least some of data associated with the autonomous driving devices and data associated with the passage and may transmit the determined driving paths to the autonomous driving devices. The third autonomous driving device 161 may perform autonomous driving along the driving path received from the second control server 120.

For example, when the autonomous driving device registered with the second control server 120 and the autonomous driving device registered with the first control server 110 meet with each other on the passage, the second control server 120 may determine whether the autonomous driving devices are able to perform cross driving and pass through the passage and may determine a driving path of each of the autonomous driving devices based on the determined result. For example, when it is possible for the autonomous driving devices which run into each other to perform cross driving on the passage, the second control server 120 may provide each of the autonomous driving devices with a driving path for cross driving. When it is impossible for the autonomous driving devices which run into each other to perform cross driving on the passage, the second control server 120 may navigate a new driving path and may provide each of the autonomous driving devices with a corrected driving path. For example, the second control server 120 may provide the autonomous driving device registered with the first control server 110 with the driving path through the first control server 110.

For example, the first control server 110 may be associated with a manufacturer different from the second control server 120. For example, the first manufacturer may be different from the second manufacturer.

A second manager device 140 may control an operation of the third autonomous driving device 161 by means of the second control server 120. For example, the second control server 120 may manually control an operation of the third autonomous driving device 161 depending on an input of the manager. The third autonomous driving device 161 may perform an operation according to the control command received from the second control server 120.

One or more aspects of the autonomous driving control system 100 are not limited to those shown in FIG. 1, which may include an additional control server, an additional manager device, and/or an additional autonomous driving device. The number of autonomous driving devices connected with each control server is not limited to those shown in FIG. 1.

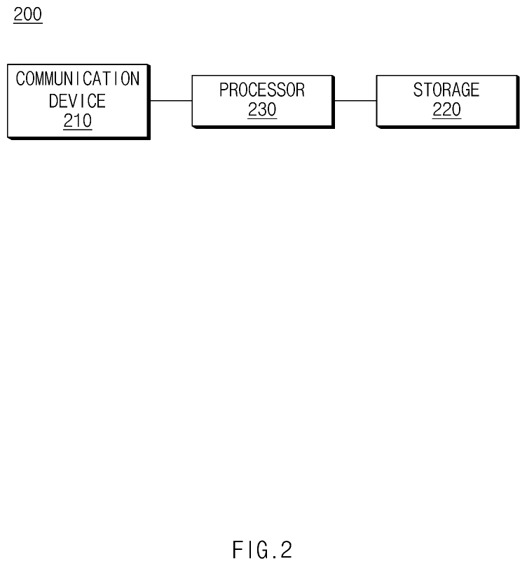

Hereinafter, a description will be given in detail of an operation of a control server (or a control device) according to various embodiments of the present disclosure with reference to FIGS. 2 to 9.

FIG. 2 is a block diagram of a control device.

A control device 200 may include a communication device 210, storage 220, and a processor 230.

The communication device 210 may transmit and receive information and/or data with an external device (e.g., an external autonomous driving device, an external control server, and/or an external manager device). For example, the communication device 210 may receive a driving path request from the external autonomous driving device. The communication device 210 may transmit information about a driving path to the external autonomous driving device. The communication device 210 may control an operation (e.g., driving path control, driving speed control, and/or notification output) of the external autonomous driving device or may transmit a control command to control a setting (e.g., a margin setting value of a sensor) of the external autonomous driving device to the external autonomous driving device. For example, the communication device 210 may receive information associated with a second external autonomous driving device, which is obtained by a first external autonomous driving device, and information associated with a passage on which the first external driving device meets with the second autonomous driving device from the first external autonomous driving device.

A communication device (e.g., the communication unit 210) may include at least one of a mobile communication module, a wireless Internet module, or a short-range communication module. The mobile communication module may communicate with the external autonomous driving device, the external control server, and/or the external manager device over a mobile communication network established according to technical standards for mobile communication or a communication scheme (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like).

The wireless Internet module may be a module for wireless Internet access, which may communicate with the external autonomous driving device, the external control server, and/or the external manager device through wireless LAN (WLAN), wireless-fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), or the like.

The storage 220 may include information associated with a plurality of autonomous driving devices. For example, the information associated with the plurality of autonomous driving devices may include identification information (e.g., a model name) of each of the plurality of autonomous driving devices, manufacturer information of each of the plurality of autonomous driving devices, size information (e.g., a height and a width) of each of the plurality of autonomous driving devices, a configuration (e.g., a 2D camera, a 3D camera, a 2D LiDAR sensor, or a 3D LiDAR sensor) of a sensor included in each of the plurality of autonomous driving devices, a margin setting value of the sensor, and/or information about a supported interaction type (e.g., text to speech (TTS), a display, or conversation). For example, the margin setting value of the sensor may indicate a minimum distance at which the sensor is able to recognize an external situation of the autonomous driving device. For example, the storage 220 may store information associated with at least one external autonomous driving device.

For example, Table 1 below indicates an example of information associated with the autonomous driving device, which is stored in the storage 220. For example, the information associated with the plurality of autonomous driving devices, which is registered in the storage 220, may include information associated with each of the autonomous driving devices. Types of autonomous driving devices, the number of the autonomous driving devices, and/or information of the autonomous driving devices, which are stored in the storage 220, are not limited to those described in Table 1 below.

TABLE 1

| Identification | | Size, sensor configuration, and sensor margin |
|---|---|---|
| information | Manufacturer | (unit: mm) |
| HR0001 | H company | {width: 800, height: 1000, sensors: [3D LiDAR, |
| | | 3D LiDAR, 3D camera], margin: 250, 250, 10} |
| HR0002 | H company | {width: 800, height: 900, sensors: [3D LiDAR, |
| | | 3D LiDAR, 3D camera], margin: 150, 150, 15} |
| KR0001 | K company | {width: 600, height: 500, sensors: [2D LiDAR, |
| | | 2D LiDAR], margin: 200, 200} |

Referring to Table 1 above, the information associated with the autonomous driving device may include identification information (e.g., a model number) of the autonomous driving device, manufacturer information of the autonomous driving device, a size of the autonomous driving device, a sensor configuration of the autonomous driving device, and sensor margin information of the autonomous driving device.

For example, the identification information may indicate the model number of the autonomous driving device, and the manufacturer may indicate an enterprise which manufactures or sells the autonomous driving device. For example, the size of the autonomous driving device may include width and height information of the autonomous driving device. The size of the autonomous driving device may include numerical values of a 3D length, width, and height as well as the width and the height. For example, when it is possible to change the appearance of the autonomous driving device, the size of the autonomous driving device may indicate a changeable size range.

For example, the sensor configuration and the sensor margin information may include types of respective sensors included in the autonomous driving device and margin information of the sensors. For example, referring to Table 1 above, for HR0001, it may be shown that two 2D LiDAR sensors are provided and a margin of each 3D LiDAR sensor is set to 200. For example, the sensor margin may indicate a sensing start range (i.e., a sensible range) of the sensor. For example, that the margin of the 3D LiDAR sensor is 200 mm may indicate that the 3D LiDAR sensor is able to sense and identify an external object from a range away by 0.2 m. For example, referring to HR0001 in Table 1 above, a margin of each of the two side 3D LiDAR sensors is 0.25 m at a width of 0.8 m for HR0001. Thus, safe driving may be ensured on a road having a width greater than or equal to 1.3 m (=0.8 m+0.25 m+0.25 m) for HR0001. For example, assuming that HR0001 drives using only one LiDAR sensor, it may be possible for HR0001 to drive on a road having a width greater than or equal to 1.05 m (=0.8 m+0.25 m). When HR0001 decelerates to a general speed or less to drive, safe driving may be ensured on a road having a width greater than or equal to 1.05 m. For example, when driving in a space of a passage having a width of 1.05 m, HR0001 may be close to one edge of the passage (e.g., an edge in a right direction of HR0001) and may drive on the passage at a decelerated speed while using only a LiDAR sensor in an opposite direction (e.g., a left direction of HR0001).

If the control device 200 is associated with a first manufacturer (e.g., H company), the storage 220 may include data associated with autonomous driving devices manufactured by the first manufacturer. For example, when there is no data associated with an autonomous driving o device (e.g., KR0001) associated with a second manufacturer (e.g., K company), the control device 200 may request data associated with the autonomous driving device associated with the second manufacturer from the external control device 200 associated with the second manufacturer through the communication device 210 and may receive the data associated with the autonomous driving device (e.g., KR0001) associated with the second manufacturer (e.g., K company) from the external control device 200. For example, the storage 220 may store data associated with the autonomous driving device (e.g., KR001) associated with the second manufacturer, which is received from an external control server associated with the second manufacturer. The storage 220 may store a cross-driving rule of the autonomous driving device in a situation where the autonomous driving devices perform cross driving. For example, in a situation where the plurality of autonomous driving devices run into each other on the passage, the cross-driving rule may define a rule of an operation performed for cross driving by each of the autonomous driving devices according to the situation. For example, the cross-driving rule may include a criterion for determining an autonomous driving device to drive along the passage and an autonomous driving device to move to an edge of the passage (e.g., an autonomous driving device to move out to the edge of the passage), based on a width of the passage, a size of each of the autonomous driving device and the external autonomous driving device, a configuration of a sensor of each of the autonomous driving device and the external autonomous driving device, and a margin of the sensor.

For example, the storage 220 may store the cross-driving rule corresponding to the plurality of autonomous driving devices registered in the storage 220.

For example, Table 2 below indicates an example of the cross-driving rule stored in the storage 220. However, the cross-driving rule is not limited to those described in Table 2 below.

TABLE 2

| Identification | | | |
|---|---|---|---|
| information | HR0001 | HR0002 | KR0001 |
| HR0001 | Space sufficiency: | Space sufficiency: | Space sufficiency: |
| | drive right | drive right | drive right |
| | Space insufficiency: | Space insufficiency: | Space insufficiency: |
| | the one which first | HR0001 drives when | HR0001 drives when |
| | discovers it drives | it is possible for | it is possible for |
| | and the other moves | HR0001 to drive and | HR0001 to drive and |
| | to the right | HR0002 slowly drives | KR0001 slowly |
| | Caution: margin of | when it is possible | drives when it is |
| | 80%, slowly drive | for only HR0002 to | possible for only |
| | Cross-driving | drive | KR0001 to drive |
| | impossibility: | Caution: margin of | Caution: margin of |
| | manager notification | 80%, slowly drive | 80%, slowly drive |
| | | Cross-driving | Cross-driving |
| | | impossibility: | impossibility: |
| | | manager notification | manager notification |
| HR0002 | Space sufficiency: | Space sufficiency: | Space sufficiency: |
| | drive right | drive right | drive right |
| | Space insufficiency: | Space insufficiency: | Space sufficiency: |
| | HR0001 drives when | the one which first | KR0001 drives when |
| | it is possible for | discovers it drives | it is possible for |
| | HR0001 to drive | and the other moves | KR0001 to drive and |
| | and HR0002 slowly | to the right | HR0002 drives when |
| | drives when it is | Caution: margin of | it is possible for |
| | possible for only | 80%, slowly drive | only HR0002 to drive |
| | HR0002 to drive | Cross-driving | Caution: margin of |
| | Caution: margin of | impossibility: | 80%, slowly drive |
| | 80%, slowly drive | manager notification | Cross-driving |
| | Cross-driving | | impossibility: |
| | impossibility: | | manager notification |
| | manager notification | | |
| KR0001 | Space sufficiency: | Space sufficiency: | Space sufficiency: |
| | drive right | drive right | drive right |
| | Space insufficiency: | Space insufficiency: | Space insufficiency: |
| | HR0001 drives when | KR0001 drives when | the one which first |
| | it is possible for | it is possible for | discovers it drives |
| | HR0001 to drive | KR0001 to drive and | and the other moves |
| | and KR0001 slowly | HR0002 drives when | to the right |
| | drives when it is | it is possible for | Caution: margin of |
| | possible for only | only HR0002 to drive | 80%, slowly drive |
| | HR0002 to drive | Caution: margin of | Cross-driving |
| | Caution: margin | 80%, slowly drive | impossibility: |
| | of 80%, slowly drive | Cross-driving | manager notification |
| | Cross-driving | impossibility: | |
| | impossibility: | manager notification | |
| | manager notification | | |

For example, in table 2 above, “space sufficiency” may indicate that the width of the passage is greater than or equal to the width obtained by adding all of widths and sensor margins of two autonomous driving devices, “space insufficiency” 5 may indicate that it is possible for at least one autonomous driving device to drive in the width of the passage when not considering a margin of at least one sensor (i.e., when not using the at least one sensor), “caution” may indicate that it is possible for the at least one autonomous driving device to perform cross driving in the width of the passage by decreasing a sensor margin of the at least one autonomous driving device to a specified value (or a specified rate), and “cross-driving impossibility” may indicate that the width of the passage is narrow to a degree to which it is impossible to the autonomous driving devices to perform cross driving.

The storage 220 may include information associated with an external facility device. For example, the external facility device may include an operable device (e.g., an elevator or an automatic door) present in a specific place. For example, the operation of the external facility device may be controlled according to an application programmable interface (API) call. For example, the storage 220 may store a position of the external facility device, API information corresponding to the external facility device, and/or identification information of the external facility device. The storage 220 may store information associated with the external manager device.

The storage 220 may store instructions executed by the processor 230. The storage 220 may include at least one of storage media such as a flash memory, a hard disk, a solid state disk (SSD), a secure digital (SD) card, an embedded multimedia card (eMMC), universal flash storage (UFS), a removable disk, and/or web storage or storage media such as a random access memory (RAM), a static RAM (SRAM), a read only memory (ROM), a programmable ROM (PROM), an electrically erasable and programmable ROM (EEPROM), and/or an erasable and programmable ROM (EPROM).

The processor 230 may control an operation of the at least one external autonomous driving device. For example, the processor 230 may control driving of the first external autonomous driving device and/or driving of the second external autonomous driving device.

The processor 230 may receive a driving path request from the first external autonomous driving device associated with the control device 200 through the communication device 210. For example, the control device 200 may be associated with the at least one external autonomous driving device. For example, the control device 200 and the at least one external autonomous driving device may be associated with the same manufacturer.

The processor 230 may receive information associated with the second external autonomous driving device, which is obtained by the first external autonomous driving device, and information associated with a passage on which the first external autonomous driving device meets with the second autonomous driving device from the first autonomous driving device through the communication device 210. For example, the first external autonomous driving device may detect a surrounding object (e.g., an obstruct (e.g., the second external autonomous driving device) and/or a passage) using at least one sensor. For example, the information associated with the second external autonomous driving device may include an image obtained by capturing the second external autonomous driving device, identification information (e.g., an identification number, a QR code, or text (or a name)) of the second external autonomous driving device, manufacturer information of the second external autonomous driving device, and/or information provided by the second external autonomous driving device. For example, the information associated with the passage may include information about the width of the passage. The processor 230 may receive information associated with a state (e.g., a battery state, a sensor state (e.g., whether the sensor is fixed), and/or position information) of the first external autonomous driving device from the first external autonomous driving device.

For example, the processor 230 may receive information associated with the second external autonomous driving device and information associated with the passage together with the driving path request from the first external autonomous driving device.

The processor 230 may determine a driving path of the first external autonomous driving device and a driving path of the second external autonomous driving device based on at least a portion of the information about the plurality of autonomous driving devices, which is previously stored, the information associated with the second external autonomous driving device, the information associated with the passage, or the cross-driving rule.

The processor 230 may determine a driving path for allowing the first external autonomous driving device and the second external autonomous driving device to perform cross driving on the passage based on the size of each of the first external autonomous driving device and the second external autonomous driving device, the sensor configuration and the sensor margin of each of the first external autonomous driving device and the second external autonomous driving device, the width of the passage, and/or the previously stored cross-driving rule. For example, the processor 230 may determine a driving path for allowing the first external autonomous driving device and the second external autonomous driving device to perform cross driving on the passage and pass through the passage. For example, when the first external autonomous driving device and the second external autonomous driving device meet with each other on the passage, the processor 230 may determine an autonomous driving device to move to an edge of the passage (i.e., an autonomous driving device to move out to ensure a driving space) and an autonomous driving device to pass through the passage and may generate a driving path of each of the autonomous driving devices.

The processor 230 may generate a driving path based on information associated with a state (e.g., a battery state, a sensor state (e.g., whether the sensor is fixed), and/or position information) of the first external autonomous driving device. For example, the processor 230 may determine a length of the driving path depending on a battery capacity of the first external autonomous driving device and may determine a driving path along which it is possible for the autonomous driving device to drive based on the sensor state.

If it is identified that the second external autonomous driving device is associated with the control device 200 based on the information about the plurality of autonomous driving devices, the processor 230 may provide the first external autonomous driving device and the second external autonomous driving device with the determined driving paths. For example, when the second external autonomous driving device is associated with the control device 200 (i.e., when the control device 200 and the second external autonomous driving device correspond to the same manufacturer), the processor 230 may control an operation of the second external autonomous driving device. The processor 230 may provide the first external autonomous driving device and the second external autonomous driving device with the determined driving paths and may control the first external autonomous driving device and the second external autonomous driving device to perform cross driving on the passage along the determined driving paths.

The processor 230 may determine whether the width of the passage meets a reference width where it is possible for the first external autonomous driving device and the second external autonomous driving device to perform cross driving, based on the information about the plurality of autonomous driving devices and the information associated with the passage. If the width of the passage does not meet the reference width, the processor 230 may transmit a command to decrease a sensor margin of the first external autonomous driving device and/or a sensor margin of the second external autonomous driving device to a specified rate to the first external autonomous driving device and/or the second external autonomous driving device.

If the width of the passage does not meet the reference width, the processor 230 may transmit a command to decrease a driving speed of the first external autonomous driving device and/or a driving speed of the second external autonomous driving device to the first external autonomous driving device and/or the second external autonomous driving device. For example, when it is impossible for the autonomous driving devices to perform cross driving while maintaining a predetermined sensor margin because the width of the passage is narrow, the processor 230 may control to set a margin of at least one sensor of at least one autonomous driving device to a specified value (or a specified rate). When decreasing the sensor margin of the at least one autonomous driving device, the processor 230 may control to decrease a driving speed of the autonomous driving device.

If it is identified that the second external autonomous driving device is associated with the external control device 200, the processor 230 may transmit a control request for allowing the second external autonomous driving device to drive along the determined driving path. For example, when the second external autonomous driving device is associated with the external control device 200 (e.g., when the control device 200 and the second external autonomous driving device correspond to different manufacturers), the processor 230 may fail to directly control an operation of the second external autonomous driving device. The processor 230 may transmit a control request to control an operation (or driving) of the second external autonomous driving device to the external control device 200 capable of controlling the operation of the second external autonomous driving device.

The processor 230 may receive a response to the control request from the external control device 200. For example, the response to the control request may indicate whether the external control device 200 controls the second external autonomous driving device to drive along the driving path determined by the processor 230.

The processor 230 may provide the first external autonomous driving device with the determined driving path or the corrected driving path based on the response to the control request. For example, when the response to the control request indicates that the external control device 200 controls the second external autonomous driving device to drive along the determined driving path, the processor 230 may provide the first external autonomous driving device with the determined driving path. For example, when the response to the control request indicates that the external control device 200 does not control the second external autonomous driving device to drive along the determined driving path, the processor 230 may correct the driving path. For example, the processor 230 may correct the driving path such that the first external autonomous driving device is able to avoid the second external autonomous driving device and move to a destination. The processor 230 may provide the first external autonomous driving device with the corrected driving path. For example, when it is determined that the first external autonomous driving device is unable to avoid the second external autonomous driving device and reach the destination, the processor 230 may provide the first external autonomous driving device and/or an external manager device associated with the control device 200 with a notification that it is impossible to drive.

The processor 230 may determine whether there is a need to manipulate an external facility device (e.g., an elevator or an automatic door) when using the determined driving path. When there is the need to manipulate the external facility device, the processor 230 may call an application programming interface (API) for controlling the external facility device and may receive an API call result from the external facility device. The processor 230 may determine a corrected driving path based on the API call result. For example, when the external facility device is controlled (e.g., the elevator or the automatic door is opened) according to the API call, the processor 230 may fail to correct the previously determined driving path. For example, the processor 230 may provide the first external autonomous driving device and/or the second external autonomous driving device with the previously determined driving path. For example, if it is unable to control the external facility device (e.g., when the elevator or the automatic door is not opened) despite the API call, the processor 230 may navigate a new driving path which does not pass through the external facility device and may correct the previously determined driving path to the new driving path.

The processor 230 may determine whether the width of the passage meets the reference width where it is possible for the first external autonomous driving device and the second external autonomous driving device to perform cross driving, based on the information about the plurality of autonomous driving devices and the information associated with the passage. When the width of the passage does not meet the reference width, the processor 230 may transmit a command to decrease a sensor margin of the first external autonomous driving device to a specified rate to the first external autonomous driving device. If the width of the passage does not meet the reference width, the processor 230 may transmit a command to decrease a driving speed of the first external autonomous driving device to the first external autonomous driving device.

The processor 230 may receive information about an autonomous driving result (e.g., a driving path, a driving speed, a driving time, whether cross driving succeeds, and/or where it reaches the destination) from the first external autonomous driving device. The processor 230 may update the cross-driving rule based on the information received from the first external autonomous driving device.

The case where the control device 200 controls the driving of the first external autonomous driving device and the driving of the second external autonomous driving device is described with reference FIG. 2, but not limited thereto. The control device 200 may control cross driving of two or more autonomous driving devices.

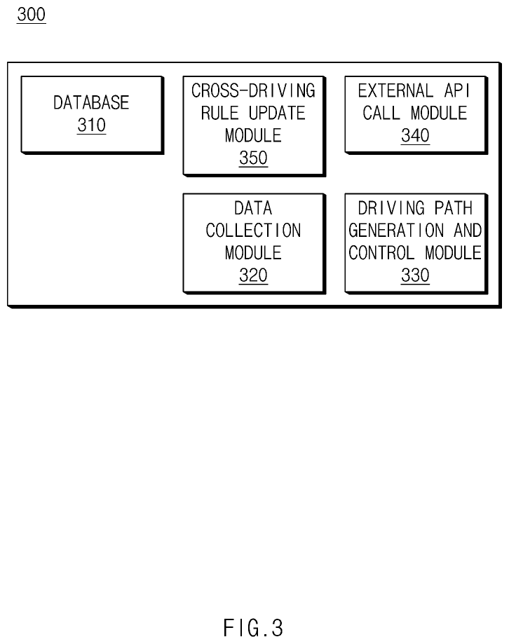

FIG. 3 is a block diagram of a control device.

A control device 300 may include a database 310, a data collection module 320, a driving path generation and control module 330, an external application programming interface (API) call module 340, and a cross-driving rule update module 350.

The database 310 may include information associated with a plurality of autonomous driving devices. For example, the information associated with the plurality of the autonomous driving devices may include identification information (e.g., a model name) of each of the plurality of autonomous driving devices, manufacturer information of each of the plurality of autonomous driving devices, size information (e.g., a height and a width) of each of the plurality of autonomous driving devices, a configuration (e.g., a 2D camera, a 3D camera, a 2D LiDAR sensor, or a 3D LiDAR sensor) of a sensor included in of each of the plurality of autonomous driving devices, a margin setting value of the sensor, and/or information about a supported interaction type (e.g., text to speech (TTS), display, or conversation). For example, the margin setting value of the sensor may indicate a minimum distance at which the sensor is able to recognize an external situation of the autonomous driving device. For example, the database 310 may store information associated with at least one external autonomous driving device.

The database 310 may store a cross-driving rule of the autonomous driving device in a situation where the autonomous driving devices perform cross driving. For example, in a situation where the plurality of autonomous driving devices run into each other on the passage, the cross-driving rule may define a rule of an operation performed for cross driving by each of the autonomous driving devices according to the situation. For example, the cross-driving rule may include a criterion for determining an autonomous driving device to drive along the passage and an autonomous driving device to move to an edge of the passage (e.g., an autonomous driving device to move out to the edge of the passage), based on the width of the passage, the size of each of the autonomous driving device and the external autonomous driving device, the configuration of the sensor, and the margin of the sensor. For example, the database 310 may store a cross-driving rule corresponding to the plurality of autonomous driving devices registered in storage.

The database 310 may include information associated with an external facility device. For example, the external facility device may include an operable device (e.g., an elevator or an automatic door) present in a specific place. For example, the operation of the external facility device may be controlled according to an application programmable interface (API) call. For example, the database 310 may store a position of the external facility device, API information corresponding to the external facility device, and/or identification information of the external facility device. The database 310 may store information associated with an external manager device.

The data collection module 320 may receive information and/or data from an external device (e.g., an external autonomous driving device, an external control server, and/or the external manager device). For example, the data collection module 320 may receive a driving path request from the external autonomous driving device. For example, the data collection module 320 may receive information associated with a second external autonomous driving device, which is obtained by a first external autonomous driving device, and information associated with a passage on which the first external autonomous driving device meets with the second autonomous driving device from the first autonomous driving device. For example, the data collection module 320 may receive information associated with a state (e.g., a battery state, a sensor state (e.g., whether a sensor fails), and/or position information) of a first external device.

The driving path generation and control module 330 may control an operation of the at least one external autonomous driving device. For example, the driving path generation and control module 330 may control driving of the first external autonomous driving device and/or driving of the second external autonomous driving device. For example, the driving path generation and control module 330 may determine a driving path of the first external autonomous driving device and/or a driving path of the second external autonomous driving device and may provide the first external autonomous driving device and/or the second external autonomous driving device with the determined driving paths.

The driving path generation and control module 330 may determine driving paths of the first external autonomous driving device and the second external autonomous driving device based on at least a portion of information about the plurality of autonomous driving devices, which is previously stored, information associated with the second external autonomous driving device, information associated with the passage, or the cross-driving rule.

The driving path generation and control module 330 may determine driving paths for allowing the first external autonomous driving device and the second external autonomous driving device to perform cross driving on the passage based on the size of each of the first external autonomous driving device and the second external autonomous driving device, the sensor configuration and the sensor margin of each of the first external autonomous driving device and the second external autonomous driving device, a width of the passage, and/or the previously stored cross-driving rule. For example, the driving path generation and control module 330 may determine driving paths for allowing the first external autonomous driving device and the second external autonomous driving device to perform cross driving on the passage and pass through the passage. For example, when the first external autonomous driving device and the second external autonomous driving device meet with each other on the passage, the driving path generation and control module 330 may determine an autonomous driving device to move to an edge of the passage (i.e., an autonomous driving device to move out to ensure a driving space) and an autonomous driving device to pass through the passage and may generate a driving path of each of the autonomous driving devices.

The driving path generation and control module 330 may generate a driving path based on information associated with a state (e.g., a battery state, a sensor state (e.g., whether a sensor is fixed), and/or position information) of the first external autonomous driving device. For example, the driving path generation and control module 330 may determine a length of the driving path depending on a battery capacity of the first external autonomous driving device and may determine a driving path along which it is possible for the autonomous driving device to drive based on the sensor state.

If it is identified that the second external autonomous driving device is associated with the control device 300 based on the information about the plurality of autonomous driving devices, the driving path generation and control module 330 may provide the first external autonomous driving device and the second external autonomous driving device with the determined driving paths. For example, when the second external autonomous driving device is associated with the control device 300 (e.g., when the control device 300 and the second external autonomous driving device correspond to the same manufacturer), the driving path generation and control module 330 may control an operation of the second external autonomous driving device. The driving path generation and control module 330 may provide the first external autonomous driving device and the second external autonomous driving device with the determined driving paths and may control the first external autonomous driving device and the second external autonomous driving device to perform cross driving on the passage along the determined driving paths.

The driving path generation and control module 330 may determine whether the width of the passage meets a reference width where it is possible for the first external autonomous driving device and the second external autonomous driving device to perform cross driving, based on the information about the plurality of autonomous driving devices and the information associated with the passage. If the width of the passage does not meet the reference width, the driving path generation and control module 330 may transmit a command to decrease a sensor margin of the first external autonomous driving device and/or a sensor margin of the second external autonomous driving device to a specified rate to the first external autonomous driving device and/or the second external autonomous driving device. If the width of the passage does not meet the reference width, the driving path generation and control module 330 may transmit a command to decrease a driving speed of the first external autonomous driving device and/or a driving speed of the second external autonomous driving device to the first external autonomous driving device and/or the second external autonomous driving device. For example, when it is impossible for the autonomous driving devices to perform cross driving while maintaining a predetermined sensor margin because the width of the passage is narrow, the driving path generation and control module 330 may control to set a margin of at least one sensor of at least one autonomous driving device to a specified value (or a specified rate). When decreasing the sensor margin of the at least one autonomous driving device, the driving path generation and control module 330 may control to decrease a driving speed of the autonomous driving device.

If it is identified that the second external autonomous driving device is associated with the external control device 300, the driving path generation and control module 330 may transmit a control request for allowing the second external autonomous driving device to drive along the determined driving path. For example, when the second external autonomous driving device is associated with the external control device 300 (i.e., when the control device 300 and the second external autonomous driving device correspond to different manufacturer), the driving path generation and control module 330 may fail to directly control an operation of the second external autonomous driving device. The driving path generation and control module 330 may transmit a control request to control an operation (or driving) of the second external autonomous driving device to the external control device 300 capable of controlling the operation of the second external autonomous driving device.

The driving path generation and control module 330 may receive a response to the control request from the external control device 300. For example, the response to the control request may indicate whether the external control device 300 controls the second external autonomous driving device to drive along the driving path determined by the driving path generation and control module 330.

The driving path generation and control module 330 may provide the first external autonomous driving device with the determined driving path or the corrected driving path based on the response to the control request. For example, when the response to the control request indicates that the external control device 300 is able to control the second external autonomous driving device to drive along the determined driving path, the driving path generation and control module 330 may provide the first external autonomous driving device with the determined driving path. For example, when the response to the control request indicates that the external control device 300 is unable to control the second external autonomous driving device to drive along the determined driving path, the driving path generation and control module 330 may correct the driving path. For example, the driving path generation and control module 330 may correct a driving path such that the first external autonomous driving device is able to avoid the second external autonomous driving device and move to a destination. The driving path generation and control module 330 may provide the first external autonomous driving device with the corrected driving path. For example, if it is determined that the first external autonomous driving device is unable to avoid the second external autonomous driving device and reach the destination, the driving path generation and control module 330 may provide the first external autonomous driving device and/or an external manager device associated with the control device 300 with a notification that it is impossible to drive.

The driving path generation and control module 330 may correct the driving path of the first external autonomous driving device and/or the driving path of the second external autonomous driving device based on the API call result received from the external API call module 340. For example, the driving path generation and control module 330 may generate a driving path including a space connected with the passage depending on manipulation of an external facility device based on the API call result received from the external API call module 340. The driving path generation and control module 330 may provide the first external autonomous driving device and/or the second external autonomous driving device with the corrected driving paths based on the API call result received from the external API call module 340.

The external API call module 340 may determine whether there is a need to manipulate the external facility device (e.g., an elevator or an automatic door) for the first external autonomous driving device and the second external autonomous driving device to use the driving path determined by the driving path generation and control module 330. When there is the need to manipulate the external facility device, the external API call module 340 may call an application programming interface (API) for controlling the external facility device and may receive an API call result from the external facility device. The external API call module 340 may provide the driving path generation and control module 330 with the API call result.

The cross-driving rule update module 350 may update a cross-driving rule based on the data collected by the data collection module 320. For example, the cross-driving rule update module 350 may update the cross-driving rule based on information about an autonomous driving result (e.g., a driving path, a driving speed, a driving time, whether cross-driving succeeds, and/or whether it reaches a destination) of the first external autonomous driving device.

The database 310, the data collection module 320, the driving path generation and control module 330, the external API call module 340, and the cross-driving rule update module 350 are illustrated as the configuration of the one control device 300 in FIG. 3. However, at least some of the database 310, the data collection module 320, the driving path generation and control module 330, the external API call module 340, and the cross-driving rule update module 350 may be implemented as an independent device or server. In this case, the independent components may be conjunction with each other to perform the operation of the control device 300, which is described above.

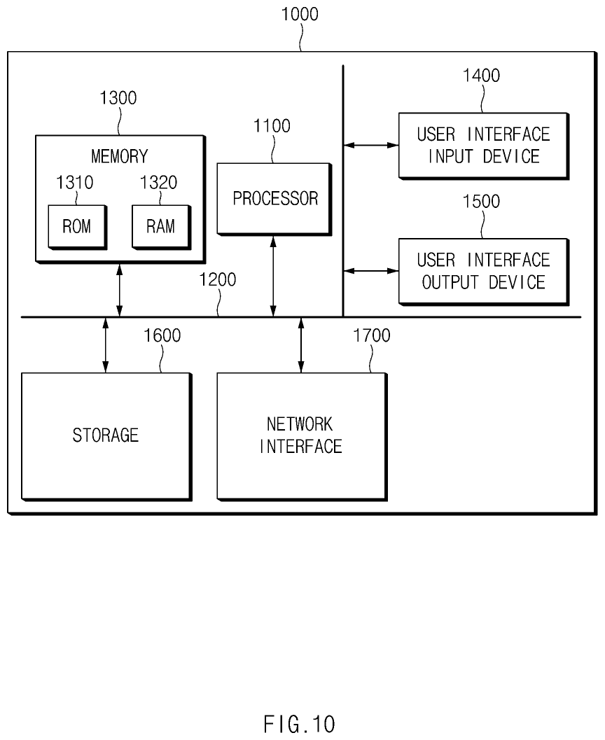

The data collection module 320, the driving path generation and control module 330, the external API call module 340, and the cross-driving rule update module 350 are illustrated and described as separate components. However, at least some of the data collection module 320, the driving path generation and control module 330, the external API call module 340, and the cross-driving rule update module 350 may be implemented as one component. For example, at least some of the data collection module 320, the driving path generation and control module 330, the external API call module 340, and the cross-driving rule update module 350 may be included in a processor 230 of FIG. 2. The data collection module 320 may be included in a communication device 210 of FIG. 2. The database 310 may be included in storage 220 of FIG. 2. The components of the control server 300 are not limited to those shown in FIG. 3. Some of the components of the control server 300 may be omitted or at least one component (e.g., at least one of components of FIG. 10) may be added to the components of the control server 300.

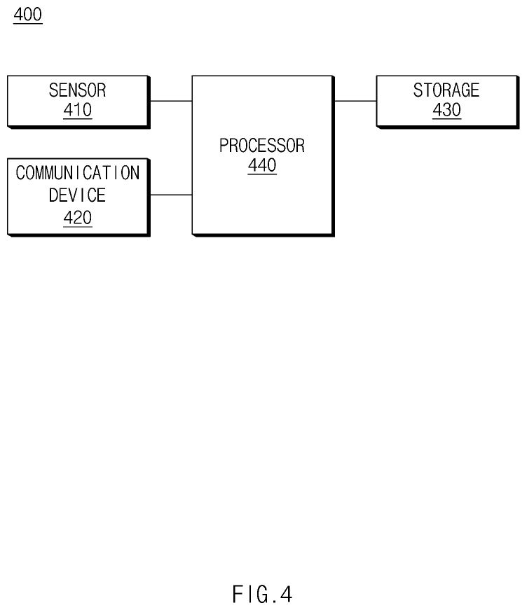

FIG. 4 is a block diagram of an autonomous driving device.

An autonomous driving device 400 may include at least one sensor 410, a communication device 420, storage 430, and a processor 440.

The at least one sensor 410 may include an image sensor 410 (e.g., a camera) and a LiDAR sensor 410. For example, the image sensor 410 may generate an image by capturing the outside of the autonomous driving device 400. For example, the image sensor 410 may capture an image including an external obstacle (e.g., the external autonomous driving device 400). For example, the LiDAR sensor 410 may obtain information about an external object of the autonomous driving device 400 (e.g., at least one of a building, a structure, a person, an external device (e.g., another autonomous driving device 400), an external object, or a combination thereof). The at least one sensor 410 may obtain identification information of the external autonomous driving device 400. For example, the sensor 410 may obtain an image of the external autonomous driving device 400, text (e.g., an identification number) included in the external autonomous driving device 400, or identification provided by the external information (e.g., a QR code) autonomous driving device 400.

For example, each of the at least one sensor 410 may have a predetermined margin value. For example, the margin value of the sensor 410 may indicate a reference distance at which the sensor 410 is able to obtain information about the external object. For example, each sensor 410 may have a blind spot and may have a range where the external object is able to be sensed. For example, when the sensor 410 is present at a distance closer than a margin value from the external object, it may fail to obtain suitable data for recognizing the external object. For example, the autonomous driving device 400 may require a space greater than or equal to the margin value of the sensor 410 to recognize the external object and smoothly perform autonomous driving. For example, the autonomous driving device 400 may detect a forward obstacle in a space wider than a value obtained by adding the margin value of the sensor 410 to a size (or a width) of the body of the autonomous driving device 400 and may avoid the obstacle to drive.

The sensor 410 included in the autonomous driving device 400 is not limited to the image sensor 410 and the LiDAR sensor 410, which may include various other sensors 410 (e.g., an ultrasonic sensor 410, a radar sensor 410, an infrared (IR) sensor 410, an acceleration sensor 410, a gyro sensor 410, a position sensor 410 (e.g., a GPS), and/or a proximity sensor 410).

The communication device 420 may transmit and receive information and/or data with an external device (e.g., an external autonomous driving device 400, an external control server, and/or an external manager device). For example, the communication device 420 may transmit information associated with the external autonomous driving device 400 (e.g., an image, identification information, or size information of the external autonomous driving device 400) and/or information associated with a passage on which the autonomous driving device 400 meets with the external autonomous driving device 400 to the external control device (e.g., width information of the passage). The communication device 420 may transmit a driving path request to the external control server. The communication device 420 may receive information about a driving path along which the autonomous driving device 400 reaches a destination from the external control server. The communication device 420 may receive information associated with another autonomous driving device 400, a cross-driving rule, and/or a command to control an operation (e.g., autonomous driving and/or notification providing) or a setting (e.g., a margin setting of the sensor 410) of the autonomous driving device 400 from the external control server. The communication device 420 may transmit an autonomous driving result (e.g., whether cross-driving succeeds or fails, a time taken to drive, a driving path, a result of being applied to a cross-driving rule) to the external control server.

A communication device (e.g., the communication unit 420) may include at least one of a mobile communication module, a wireless Internet module, or a short-range communication module. The mobile communication module may communicate with the external autonomous driving device 400, the external control server, and/or the external manager device over a mobile communication network established according to technical standards for mobile communication or a communication scheme (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like). The wireless Internet module may be a module for wireless Internet access, which may communicate with the external autonomous driving device 400, the external control server, and/or the external manager device through wireless LAN (WLAN), wireless-fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (LTE), long term evolution-(HSUPA), long term evolution advanced (LTE-A), or the like. The short-range communication module may communicate with the external autonomous driving device 400, the external control server, and/or the external manager device using at least one of Bluetooth™, radio frequency identification (RFID), infrared data association (IrDA), ultra wideband (UWB), ZigBee, near field communication (NFC), and wireless universal serial bus (USB) technologies.

The storage 430 may store the information obtained by means of the sensor 410. For example, the storage 430 may store the image captured by using the camera. The storage 430 may store the information obtained using the LiDAR sensor 410. The storage 430 may store data associated with performing an operation, a function, and/or a service of the autonomous driving device 400. The storage 430 may store information associated with autonomous driving. For example, the storage 430 may store information associated with the driving path. The storage 430 may store the cross-driving rule.

The storage 430 may store instructions executed by the processor 440. The storage 430 may include at least one of storage media such as a flash memory, a hard disk, a solid state disk (SSD), a secure digital (SD) card, an embedded multimedia card (eMMC), universal flash storage (UFS), a removable disk, and/or web storage or storage media such as a random access memory (RAM), a static RAM (SRAM), a read only programmable ROM (PROM), an electrically memory (ROM), a erasable and programmable ROM (EEPROM), and/or an erasable and programmable ROM (EPROM).

The processor 440 may recognize the external autonomous driving device 400 (e.g., the second external autonomous driving device 400) which is present on a passage on a first driving path set to a destination using the at least one sensor 410. For example, the processor 440 may obtain an image by capturing the front (e.g., a driving path direction) of the autonomous driving device 400 using the camera and may analyze the image to detect the external autonomous driving device 400. For example, the processor 440 may obtain data by sensing the periphery of the autonomous driving device 400 using the LiDAR sensor 410 and may recognize objects around the autonomous driving device 400 based on the obtained data.

The processor 440 may transmit the information obtained using the at least one sensor 410 to the external control server through the communication device 420 and may receive a driving path, a cross-driving rule, and/or a control command from the external control server.

The processor 440 may control the overall operation of the autonomous driving device 400. For example, the processor 440 may control driving of the autonomous driving device 400 based on the driving path and/or the cross-driving rule received from the external control server. The processor 440 may control autonomous driving such that the autonomous driving device 400 reaches a destination along the driving path and may control the autonomous driving device 400 to provide a specified service (e.g., product delivery) at the destination.

The components of the autonomous driving device 400 are not limited to those shown in FIG. 4, which may further include an additional component (e.g., at least one of components of FIG. 10). For example, the autonomous driving device 400 may further include a mobility device (not shown) (e.g., a wheel or a leg) and/or a driving device for controlling the mobility device. For example, the autonomous driving device 400 may further include a display (or a touch screen) for visually displaying information and/or a speaker for audibly outputting information.

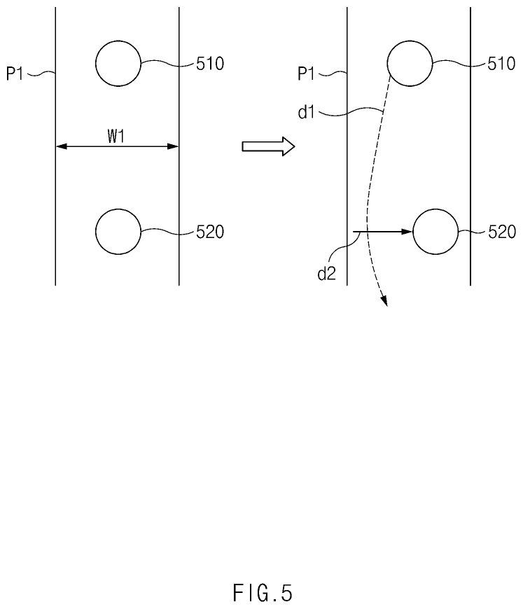

Hereinafter, a description will be given of the operation of the control device with reference to FIGS. 5 to 7. Hereinafter, it is assumed that a first control server 100 of FIG. 1 (or a control device 200 of FIG. 2 or a control device 300 of FIG. 3) performs operations of FIGS. 5 to 7. Furthermore, in a description of FIGS. 5 to 7, an operation described as being performed by the control device may be understood as being controlled by a processor 230 of an autonomous driving device 200 (or a data collection module 320, a driving path generation and control module 330, an external API call module 340, and a cross-driving rule update module 350 of FIG. 3).

FIG. 5 is a drawing for describing an operation where a control device controls driving of an autonomous driving device. FIG. 5 illustrates a situation where a first autonomous driving device 510 (e.g., HR0001 in Tables 1 and 2 above) and a second autonomous driving device 520 (e.g., HR0002 in Tables 1 and 2 above) meet with each other on a passage P1 with a width W1.

If the width W1 of the passage P1 is greater than a value obtained by adding all of a width and a sensor margin of the first autonomous driving device 510 and a width and a sensor margin of the second autonomous driving device 520 (e.g., when there is “space sufficiency” in a cross-driving rule in Table 2 above), the first autonomous driving device 510 and the second autonomous driving device 520 may perform cross driving on the passage P1 and may pass through the passage P1 without difficulty. For example, a description will be given assuming that the width of the first autonomous driving device 510 is 0.8 m, each of two LiDAR sensor margins included in the first autonomous driving device 510 is 0.25 m, the width of the second autonomous driving device 520 is 0.8 m, and each of two LiDAR sensor margins included in the second autonomous driving device 520 is 0.15 m. When the width W1 of the passage P1 is greater than 2.4 m (=(0.8m+0.25m+0.25m)+(0.8m+0.15m+0.15m)), the first autonomous driving device 510 and the second autonomous driving device 520 may perform cross driving on the passage P1 and may pass through the passage P1 without difficulty. The control device may determine driving paths such that the first autonomous driving device 510 and the second autonomous driving device 520 perform cross driving and may provide the first autonomous driving device 510 and the second autonomous driving device 520 with the determined driving paths. For example, when the second autonomous driving device 520 is associated with an external control device, the control device may provide the second autonomous driving device 520 with the driving path through the external control device or may request the external control device to control the second autonomous driving device 520 to drive along the determined driving path. For example, the control device may determine and provide driving paths such that the first autonomous driving device 510 and the second autonomous driving device 520 may be adjacent to a right edge of the passage P1 to perform cross driving.

If the width W1 of the passage P1 is less than or equal to a value obtained by adding all the width and the sensor margin of the first autonomous driving device 510 and the width and the sensor margin of the second autonomous driving device 520 and is greater than a value obtained by adding the width of the first autonomous driving device 510, the width of the second autonomous driving device 520, and a margin of any one of sensors of the first autonomous driving device 510 and/or the second autonomous driving device 520 (e.g., when there is “space insufficiency” in the cross-driving rule in Table 2 above), the first autonomous driving device 510 and the second autonomous driving device 520 may perform cross driving on the passage P1 and may pass through the passage P1 depending on the cross-driving rule. For example, the control device may determine driving paths of the first autonomous driving device 510 and the second autonomous driving device 520 based on the cross-driving rule stored in storage.

For example, when the first autonomous driving device 510 drives using only one LiDAR sensor (or a sensor margin), there is a need for a space having a width greater than 1.85 m obtained by adding a width of 0.8 mm of the first autonomous driving device 510, a sensor margin of 0.25 m of the first autonomous driving device 510, and a width of 0.8 m of the second autonomous driving device 520. When the second autonomous driving device 520 drives using only one LiDAR sensor (or a sensor margin), there is a need for a space having a width greater than 1.75 m obtained by adding a width of 0.8 m of the second autonomous driving device 520, a sensor margin of 0.15 m of the second autonomous driving device 520, and a width of 0.8 m of the first autonomous driving device 510. When the width W1 of the passage P1 is greater than 1.85 m, both the first autonomous driving device 510 and the second autonomous driving device 520 may drive on the passage P1. However, the control device may determine a driving path d1 of the first autonomous driving device 510 and a driving path d2 of the second autonomous driving device 520 to form a space through which the first autonomous driving device 510 is able to pass as the first autonomous driving device 510 drives on the passage P1 in a priority defined in the cross-driving rule and the second autonomous driving device 520 moves to a right edge of the passage P1. When the width W1 of the passage P1 is 1.8 m, because the first autonomous driving device 510 is unable to drive on the passage P1 and only the second autonomous driving device 520 is able to drive on the passage P1, the control device may form a space through which the second autonomous driving device 520 is able to pass as the first autonomous driving device 510 moves to a right edge of the passage P1 and may determine driving paths of the first autonomous driving device 510 and the second autonomous driving device 520 such that the second autonomous driving device 520 drives on the passage P1. Likewise, referring to Table 2 above, for “space insufficiency”, the control device may determine a driving path such that the first autonomous driving device 510 drives on the passage P1 in a higher priority between the first autonomous driving device 510 and a third autonomous driving device (e.g., KR0001 in Tables 1 and 2) and may determine a driving path such that the third autonomous driving device drives on the passage P1 in a higher priority between the second autonomous driving device 520 and the third autonomous driving device.

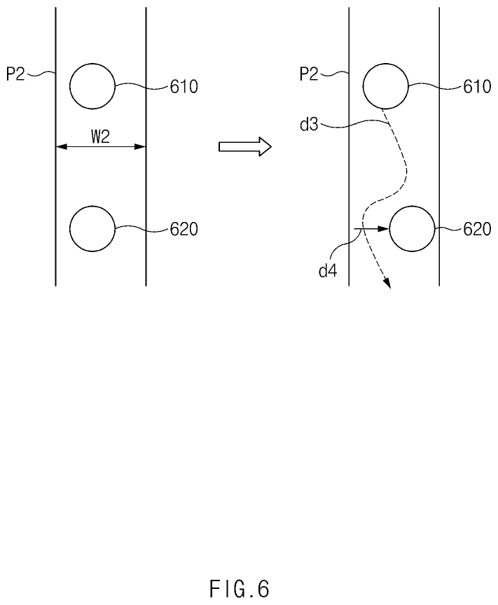

FIG. 6 is a drawing for describing an operation where a control device controls driving of an autonomous driving device. FIG. 6 illustrates a situation where a first autonomous driving device 610 (e.g., HR0001 in Tables 1 and 2 above) and a second autonomous driving device 620 (e.g., HR0002 in Tables 1 and 2 above) meet with each other on a passage P2 with a width W2.

If it is possible to change a margin of at least one sensor of the first autonomous driving device and/or the second autonomous driving device, the control device may decrease and set the sensor margin of the first autonomous driving device and/or the sensor of the second autonomous driving device to a specified value (or a specified rate).

Hereinafter, a description will be given assuming that the control device decreases and sets the sensor margin of the first autonomous driving device to 60% of a reference value (or an initial setting value). However, a change value or a change rate of the sensor margin is not limited thereto. For example, the control device may transmit a command to decrease the sensor margin to 60% to the first autonomous driving device. The first autonomous driving device may decrease and set the sensor margin to 60% based on the command received from the control device. For example, when the initially set sensor margin of the first autonomous driving device is 0.25 m, the first autonomous driving device may set the sensor margin to 0.15 m. For example, because the sensor margin of the first autonomous driving device is changed, it may be possible for the first autonomous driving device to drive on the passage.

If the width W2 of the passage P2 is less than or equal to a value obtained by adding the width of the first autonomous driving device 610, the width of the second autonomous driving device 620, and the initially set margin of any one of sensors of the first autonomous driving device 610 and/or the second autonomous driving device 620 and is greater than a value obtained by adding the width of the first autonomous driving, the width of the second autonomous driving device 620, and the changed margin of any one of the sensors of the first autonomous driving device 610 and/or the second autonomous driving device 620 (e.g., when there is “caution” in the cross-driving rule in Table 2 above), the first autonomous driving device 610 and the second autonomous driving device 620 may perform cross driving on the passage P2 and pass through the passage P2 depending on the cross-driving rule. For example, after changing the sensor margin of the first autonomous driving device 610 and/or the sensor margin of the second autonomous driving device 620 based on the cross-driving rule stored in the storage, the control device may determine driving paths of the first autonomous driving device 610 and the second autonomous driving device 620.

For example, considering the initially set sensor margin, when the first autonomous driving device 610 drives using only one LiDAR sensor (or a sensor margin), there is a need for a space having a width greater than 1.85 m obtained by adding a width of 0.8 mm of the first autonomous driving device 610, an initially set sensor margin of 0.25 m of the first autonomous driving device 610, and a width of 0.8 m of the second autonomous driving device 620. Considering the changed sensor margin, when the first autonomous driving device 610 drives using only one LiDAR sensor (or a sensor margin), there is a need for a space having a width greater than 1.75 m obtained by adding a width of 0.8 mm of the first autonomous driving device 610, a changed sensor margin of 0.15 m of the first autonomous driving device 610, and a width of 0.8 m of the second autonomous driving device 620.

When the width W2 of the passage P2 is greater than 1.75 m and is less than or equal to 1.85 m, only the second autonomous driving device 620 may drive on the passage before the sensor margin of the first autonomous driving device 610 is changed. However, when the sensor margin of the first autonomous driving device 610 decreases, both the first autonomous driving device 610 and the second autonomous driving device 620 may drive on the passage P2. In this case, for example, the control device may determine a driving path d3 of the first autonomous driving device 610 and a driving path d4 of the second autonomous driving device 620 to form a space through which the first autonomous driving device 610 is able to pass as the first autonomous driving device 610 drives on the passage P2 in a priority defined in the cross-driving rule and the second autonomous driving device 620 moves to a right edge of the passage P2.

When the sensor margin decreases, the first autonomous driving device 610 may perform cross driving at a distance closer to an external object (e.g., the second autonomous driving device 620). When decreasing the sensor margin of the first autonomous driving device 610, the control device may more decrease a driving speed of the first autonomous driving device 610 than a reference speed. For example, the control device may transmit to decrease the driving speed to a speed lower than the reference speed (or a predetermined speed) to the first autonomous driving device 610.

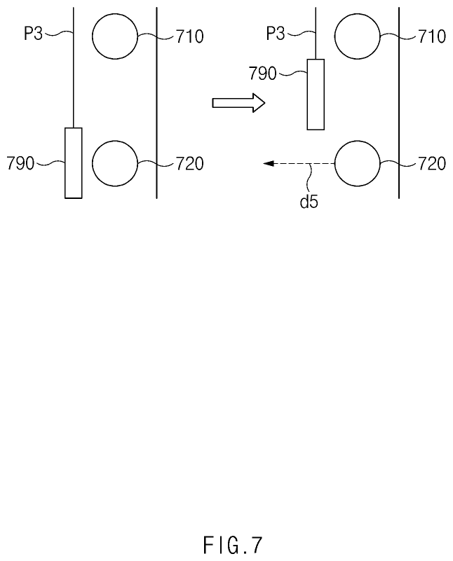

FIG. 7 is a drawing for describing an operation where a control device controls driving of an autonomous driving device. FIG. 7 illustrates a situation where a first autonomous driving device 710 and a second autonomous driving device 720 meet with each other on a passage P3 including an external facility device 790 (e.g., automatic door or an elevator).

For example, when the width of the passage P3 is less than or equal to a value obtained by adding the width of the first autonomous driving device 710, the width of the second autonomous driving device 720, and a margin of any one of sensors of the first autonomous driving device 710 and/or the second autonomous driving device 720 (e.g., when there is “cross-driving impossibility” in Table 2 above), the first autonomous driving device 710 and the second autonomous driving device 720 may fail to perform cross driving on the passage P3. However, when the passage P3 includes the external facility device 790 connected with another space, the first autonomous driving device 710 and the second autonomous driving device 720 may perform cross driving on the passage P3 through the external facility device 790. For example, the control device may include information about the external facility device 790 (e.g., API information corresponding to the external facility device 790). The control device may call an API corresponding to the external facility device 790 and may receive an API call result from the external facility device 790. For example, the control device may call an API corresponding to an automatic door to open the automatic door or may call an API corresponding to an elevator to open a door of the elevator. For example, the control device may control the second autonomous driving device 720 to move to a space connected with the passage P3 by manipulation of the external facility device 790 (e.g., opening the automatic door). For example, the control device may generate a driving path d5 where the second autonomous driving device 720 moves to the space connected with the passage P3 and may transmit the driving path d5 to the second autonomous driving device 720. When the second autonomous driving device 720 moves to the space connected with the passage P3, the first autonomous driving device 710 may pass through the passage P3 to drive. For example, after the second autonomous driving device 720 moves to the space connected with the passage P3, the control device may generate a driving path for allowing the first autonomous driving device 710 to drive on the passage P3 and may provide a first external autonomous driving device with the driving path.

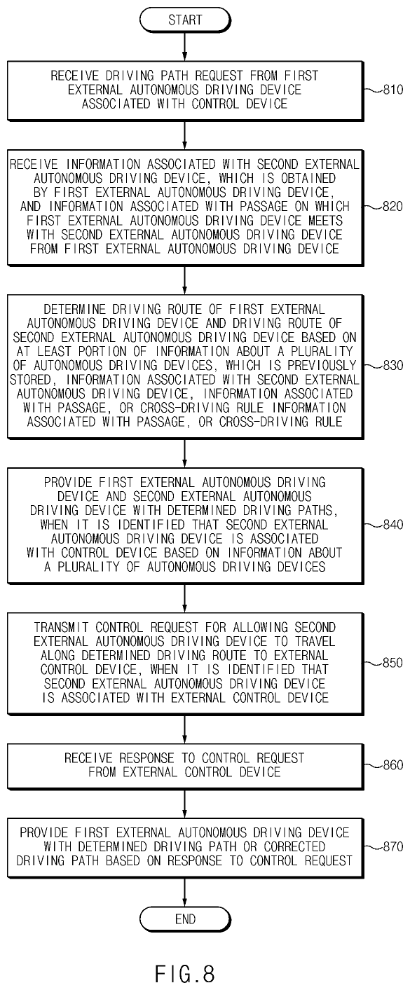

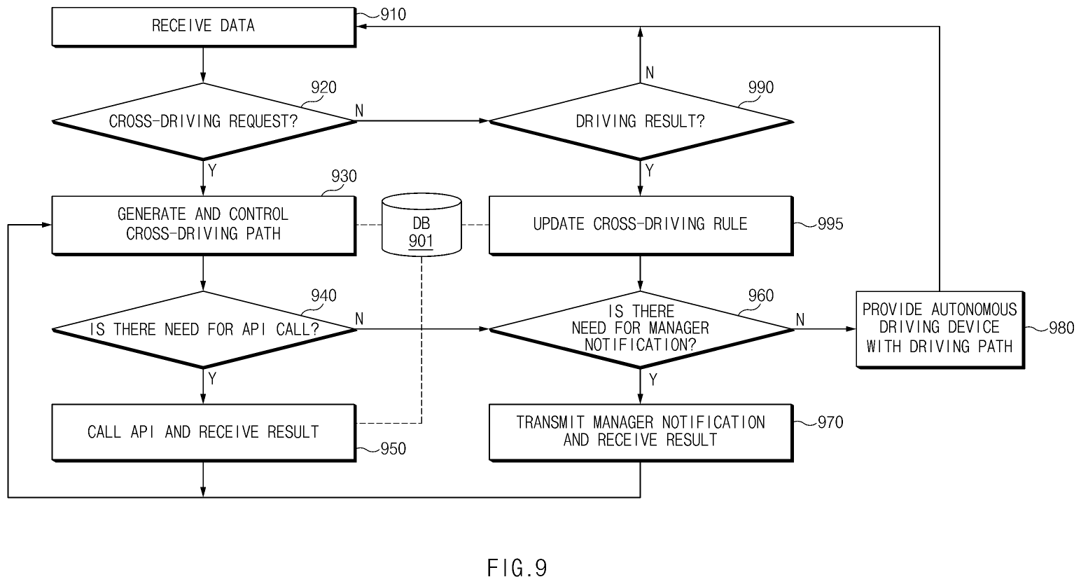

Hereinafter, a description will be given in detail of a method for controlling an autonomous driving device in a control device with reference to FIGS. 8 and 9. FIGS. 8 and 9 are flowcharts for describing a method for controlling an autonomous driving device in a control device.

Hereinafter, it is assumed that a first control server 100 of FIG. 1 (or a control device 200 of FIG. 2 or a control device 300 of FIG. 3) performs a process of FIGS. 8 to 9. Furthermore, in a description of FIGS. 8 and 9, an operation described as being performed by a control device may be understood as being controlled by a processor 230 of an autonomous driving device 200 (or a data collection module 320, a driving path generation and control module 330, an external API call module 340, and a cross-driving rule update module 350 of FIG. 3).

FIG. 8 is a flowchart of a method for controlling an autonomous driving device in a control device.

In operation 810, the control device may receive a driving path request from a first external autonomous driving device associated through the control device. For example, the control device may be associated with at least one external autonomous driving device. For example, the control device and the at least one external autonomous driving device may be associated with the same manufacturer. For example, the first external autonomous driving device may transmit a driving path request to the control server on a periodic basis or when a specified event occurs.

In operation 820, the control device may receive information associated with a second external autonomous driving device, which is obtained by the first external autonomous driving device, and information associated with a passage on which the first external autonomous driving device meets with the second autonomous driving device from the first autonomous driving device. For example, the first external autonomous driving device may detect a surrounding object (e.g., an obstacle (e.g., the second external autonomous driving device) and/or the passage) using at least one sensor. For example, the information associated with the second external autonomous driving device may include an image obtained by capturing the second external autonomous driving device, identification information (e.g., an identification number, a QR code, or text (or a name)) of the second external autonomous driving device, manufacturer information of the second external autonomous driving device, and/or information provided by the second external autonomous driving device. For example, the information associated with the passage may include information about a width of the passage. The control device may receive information associated with a state (e.g., a battery state, a sensor state (e.g., whether the sensor is fixed), and/or position information) of the first external autonomous driving device from the first external autonomous driving device.

Operation 810 and operation 820 may be performed at the same time. For example, the control device may receive the information associated with the second external autonomous driving device and the information associated with the passage together with the driving path request from the first external autonomous driving device.

In operation 830, the control device may determine a driving path of the first external autonomous driving device and a driving path of the second external autonomous driving device based on at least a portion of information about a plurality of autonomous driving devices, which is previously stored, the information associated with the second external autonomous driving device, the information associated with the passage, or a cross-driving rule.

The control device may include the information associated about the plurality of autonomous driving devices. For example, the information about the plurality of autonomous driving devices may include at least one of identification information of each of the plurality of autonomous driving devices, manufacturer information of each of the plurality of autonomous driving devices, size information of each of the plurality of autonomous driving devices, information about a sensor configuration included in each of the plurality of autonomous driving devices, or information about a margin of a predetermined sensor. For example, the control device may receive and store information associated with at least one autonomous driving device associated with at least one external control device from the external control device.

The control device may determine driving paths for allowing the first external autonomous driving device and the second external autonomous driving device to perform cross driving on the passage based on a size of each of the first external autonomous driving device and the second external autonomous driving device, a sensor configuration and a sensor margin of each of the first external autonomous driving device and the second external autonomous driving device, a width of the passage, and/or the previously stored cross-driving rule. For example, the driving path determined in operation 830 may be determined assuming that it is possible to control an operation (or driving) of the second external autonomous driving device. For example, the cross-driving rule may include a criterion for determining an autonomous driving device to drive along the passage and an autonomous driving device to move to an edge of the passage, based on the information associated with the passage and the information about the plurality of autonomous driving devices. For example, the processor 230 may determine driving paths for allowing the first external autonomous driving device and the second external autonomous driving device to perform cross driving on the passage and pass through the passage. For example, when the first external autonomous driving device and the second external autonomous driving device meet with each other on the passage, the control device may determine an autonomous driving device to move to an edge of the passage (e.g., an autonomous driving device to move out to ensure a driving space) and an autonomous driving device to pass through the passage and may generate a driving path of each of the autonomous driving devices. The control device may generate a driving path based on information associated with a state (e.g., a battery state, a sensor state (e.g., whether the sensor is fixed), and/or position information) of the first external autonomous driving device. For example, the control device may determine a length of the driving path depending on a battery capacity of the first external autonomous driving device and may determine a driving path along which it is possible for the autonomous driving device to drive based on the sensor state.

In operation 840, when it is identified that the second external autonomous driving device is associated with the control device based on the information about the plurality of autonomous driving devices, the control device may provide the first external autonomous driving device and the second external autonomous driving device with the determined driving paths. For example, when the second external autonomous driving device is associated with the control device (e.g., when the control device the second external autonomous driving device correspond to the same manufacturer), the control device may control an operation of the second external autonomous driving device. The control device may provide the first external autonomous driving device and the second external autonomous driving device with the determined driving paths and may control the first external autonomous driving device and the second external autonomous driving device to perform cross driving on the passage along the determined driving paths.

The control device may determine whether the width of the passage meets a reference width where it is possible for the first external autonomous driving device and the second external autonomous driving device to perform cross driving, based on the information about the plurality of autonomous driving devices and the information associated with the passage. When the width of the passage does not meet the reference width, the control device may transmit a command to decrease a sensor margin of the first external autonomous driving device and/or a sensor margin of the second external autonomous driving device to a specified rate to the first external autonomous driving device and/or the second external autonomous driving device. If the width of the passage does not meet the reference width, the control device may transmit a command to decrease a driving speed of the first external autonomous driving device and/or a driving speed of the second external autonomous driving device to the first external autonomous driving device and/or the second external autonomous driving device. For example, when it is impossible for the autonomous driving devices to perform cross driving while maintaining a predetermined sensor margin because the width of the passage is narrow, the control device may control to set a margin of at least one sensor of at least one autonomous driving device to a specified value (or a specified rate). When decreasing the sensor margin of the at least one autonomous driving device, the control device may control to decrease a driving speed of the autonomous driving device.

In operation 850, when it is identified that the second external autonomous driving device is associated with an external control device, the control device may transmit a control request for allowing the second external autonomous driving device to drive along the determined driving path to the external control device. For example, when the second external autonomous driving device is associated with the external control device (e.g., when the control device and the second external autonomous driving device correspond to different manufacturers), the control device may fail to directly control an operation of the second external autonomous driving device. The control device may transmit a control request to control an operation (or driving) of the second external driving device to the external control device capable of controlling the operation of the second external autonomous driving device.

In operation 860, the control device may receive a response to the control request from the external control device. For example, the response to the control request may indicate whether the external control device controls the second external autonomous driving device to drive along the driving path determined in operation 830.

In operation 870, the control device may provide the first external autonomous driving device with the determined driving path or a corrected driving path based on the response to the control request. For example, when the response to the control request indicates that the external control device controls is able to control the second external autonomous driving device to drive along the determined driving path, the control device may provide the first external autonomous driving device with the determined driving path. For example, when the response to the control request indicates that the external control is unable to control the second external autonomous driving device to drive along the determined driving path, the control device may correct the driving path determined in operation 830. For example, the control device may correct the driving path for allowing the first external autonomous driving device to avoid the second external autonomous driving device to move to a destination. The control device may provide the first external autonomous driving device with the corrected driving path. For example, when it is determined that the first external autonomous driving device is unable to avoid the second external autonomous driving device and reach the destination, the control device may provide the first external autonomous driving device and/or an external manager device associated with the control device with a notification that it is impossible to drive.

The control device may determine whether there is a need to manipulate an external facility device (e.g., an elevator or an automatic door) when using the determined driving path. When there is the need to manipulate the external facility device, the control device may call an application programming interface (API) for controlling the external facility device and may receive an API call result from the external facility device. The control device may determine the corrected driving path based on the API call result. For example, when the external facility device is controlled according to the API call (e.g., the elevator or the automatic door is opened), the control device may fail to correct the previously determined driving path. For example, the control device may provide the first external autonomous driving device and/or the second external autonomous driving device with the previously determined driving path. For example, when it is unable to control the external facility device (e.g., when the elevator or the automatic door is not opened) despite the API call, the processor 230 may navigate a new driving path which does not pass through the external facility device and may correct the previously determined driving path to the new driving path.

The control device may determine whether the width of the passage meets a reference width where it is possible for the first external autonomous driving device and the second external autonomous driving device to perform cross driving, based on the information about the plurality of autonomous driving devices and the information associated with the passage.

When the width of the passage does not meet the reference width, the control device may transmit a command to decrease a sensor margin of the first external autonomous driving device to a specified rate to the first external autonomous driving device. If the width of the passage does not meet the reference width, the control device may transmit a command to decrease a driving speed of the first external autonomous driving device to the first external autonomous driving device.

The control device may receive information about an autonomous driving result (e.g., a driving path, a driving speed, a driving time, whether cross driving succeeds, and/or when it reaches the destination) from the first external autonomous driving device. The control device may update the cross-driving rule based on the information received from the first external autonomous driving device.

FIG. 9 Is a flowchart of a method for controlling an autonomous driving device in a control device.

In operation 910, the control device may receive data from a first external autonomous driving device. For example, the data may include data associated with a cross-driving request and/or autonomous driving. For example, the data associated with the autonomous driving may include data associated with an object (e.g., an obstacle (e.g., a second external autonomous driving device) or a passage) in front of the first external autonomous driving device. For example, the data associated with the autonomous driving may include a driving result (e.g., a time taken to drive, a driving speed, a driving path, and/or whether cross driving succeeds) of the first external autonomous driving device. The control device may receive data from the first external autonomous driving device on a periodic basis or when a specified event occurs (e.g., when the first external autonomous driving device detects an obstacle).

In operation 920, the control device may determine whether the received data includes a cross-driving request. The control device may perform operation 930 when the received data includes the cross-driving request and may perform operation 990 when the received data does not include the cross-driving request.

In operation 930, the control device may generate a driving path (e.g., a cross-driving path) and may control the first external autonomous driving device. For example, the control device may generate a cross-driving path based on the data received from the first external autonomous driving device, information about the plurality of autonomous driving devices, which is stored in a DB 901, and a cross-driving rule stored in the DB 901. For example, the information about the plurality of autonomous driving devices may include at least one of identification information of each of the plurality of autonomous driving devices, manufacturer information of each of the plurality of autonomous driving devices, size information of each of the plurality of autonomous driving devices, information about a sensor configuration included in each of the plurality of autonomous driving devices, or information about a margin of a predetermined sensor. For example, the cross-driving rule may include a criterion for determining an autonomous driving device to drive along the passage and an autonomous driving device to move to an edge of the passage, based on the information about the passage and the information about the plurality of autonomous driving devices. For example, the control device may determine driving paths for allowing the first external autonomous driving device and the second external autonomous driving device to perform cross driving on the passage and pass through the passage. For example, when the first external autonomous driving device and the second external autonomous driving device meet with each other on the passage, the control device may determine an autonomous driving device to move to an edge of the passage (e.g., an autonomous driving device to move out to ensure a driving space) and an autonomous driving device to pass through the passage and may generate a cross-driving path of each of the autonomous driving devices.

The control device may correct a driving path (e.g., a cross-driving path) or may generate a new driving path (e.g., a new cross-driving path), based on an API call result obtained in operation 950 and/or a manager notification obtained in operation 960.

In operation 940, the control device may determine whether there is a need for an API call for controlling an external facility device (e.g., an elevator or an automatic door) on the driving path (e.g., the cross-driving path). For example, the control device may determine whether the driving path passes through the elevator or the automatic door. The control device may perform operation 950 when there is the need for the API call and may perform operation 960 when there is not the need for the API call.

In operation 950, the control device may call an API to control the external facility device. For example, the control device may call the API based on information associated with the external facility device, which is stored in the DB 901.

For example, the DB 901 may include information about each of external facility devices included in a space where the first external autonomous driving device provides a service (e.g., API information corresponding to the external facility device). The control device may receive an API call result from the external facility device (or an external server which controls the external facility device). For example, the API call result may include information indicating whether the operation of the external facility device is controlled. For example, when the API call result indicates that the external facility device is controlled, the control device may maintain the driving path previously generated in operation 930. For example, when the API call result indicates that the external facility device is not controlled, the control device may correct the driving path previously generated in operation 930. The control device may generate a new driving path where does not pass through the external facility device rather than the driving path previously generated in operation 930.

In operation 960, the control device may determine whether there is a need for a manager notification. For example, when it is impossible for the first external autonomous driving device to drive along the generated driving path (e.g., when autonomous driving fails), the control device may determine that there is the need for the manager notification. The control device may perform operation 970 when there is the need for the manager notification and may perform operation 980 when there is not the need for the manager notification.

In operation 970, the control device may transmit the manager notification to an external manager device. For example, the manager notification may include information indicating that it is impossible for the first external autonomous driving device to drive, that an obstacle should be cleared for driving of the first external autonomous driving device, or that there is a need to control the external facility device for driving of the first external autonomous driving device. For example, the manager notification may include information for requesting a manager to manually manipulate the first autonomous driving device. The control device may receive a result for the manager notification from a manager device. For example, the control device may wait until the result for the manager notification is received from the manager device during a specified time after transmitting the manager notification. For example, the result for the manager notification may include information indicating that the manager removes an obstacle on the driving path, information indicating that the manager controls the external facility device, and/or information indicating that the manager manually manipulates the first external autonomous driving device. If the result for the manager notification indicates that an element which obstructs the driving of the first autonomous driving device is removed, the control device may maintain the driving path previously generated in operation 930. If the result for the manager notification indicates that the element which obstructs the driving of the first autonomous driving device is not removed, the control device may correct the driving path previously generated in operation 930. The control device may generate a new driving path rather than the driving path previously generated in operation 930.

In operation 980, the control device may provide the first external autonomous driving device with the driving path (e.g., the cross-driving path). For example, as the control device provides the first external autonomous driving device with the driving path, the first external autonomous driving device may perform autonomous driving to a destination along the driving path provided from the control device.

In operation 990, the control device may determine whether the received data includes a driving result. The control device may perform operation 995 when the received data includes the driving result and may wait for receiving data from the first external autonomous driving device in operation 910 when the received data does not include the driving result.

In operation 995, the control device may update the cross-driving rule stored in the DB 901 based on the received driving result. For example, the control device may change a condition of the cross-driving rule stored in the DB 901, may correct a manner which performs cross driving in a specific situation, or may change priorities of criteria included in the cross-driving rule.

FIG. 10 is a block diagram illustrating a computing system.

Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the features and operations disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively or additionally, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an aspect of the present disclosure, a control device may include a communication device, a processor, and storage including information about a plurality of autonomous driving devices and a cross-driving rule associated with the plurality of autonomous driving devices. According to an embodiment, the processor may receive a driving path request from a first external autonomous driving device associated with the control device through the communication device, may receive information associated with a second external autonomous driving device, the information being obtained by the first external autonomous driving device, and information associated with a passage on which the first external autonomous driving device meets with the second external autonomous driving device from the first external autonomous driving device through the communication device, may determine a driving path of the first external autonomous driving device and a driving path of the second external autonomous driving device based on at least a portion of the information about the plurality autonomous driving devices, the information associated with the second external autonomous driving device, the information associated with the passage, or the cross-driving rule, may provide the first external autonomous driving device and the second external autonomous driving device with the determined driving paths through the communication device, when it is identified that the second external autonomous driving device is associated with the control device based on the information about the plurality of autonomous driving devices, may transmit a control request for allowing the second external autonomous driving device to drive along the determined driving path to an external control device through the communication device, when it is identified that the second external autonomous driving device is associated with the external control device, may receive a response to the control request from the external control device through the communication device, and may provide the first external autonomous driving device with the determined driving path or a corrected driving path through the communication device based on the response to the control request.

The information about the plurality of autonomous driving devices may include at least one of identification information of each of the plurality of autonomous driving devices, manufacturer information of each of the plurality of autonomous driving devices, size information of each of the plurality of autonomous driving devices, information about a sensor configuration included in each of the plurality of autonomous driving devices, or information about a margin of a predetermined sensor.

The cross-driving rule may include a criterion for determining an autonomous driving device to drive along the passage and an autonomous driving device to move to an edge of the passage, based on the information about the passage and the information about the plurality of autonomous driving devices.

The processor may provide the first external autonomous driving device with the determined driving path, when receiving the response indicating that it is able to control the second external autonomous driving device to drive along the determined driving path from the external control device.

The processor may correct the driving path such that the first external autonomous driving device is able to avoid the second external autonomous driving device and move to a destination, when receiving the response indicating that it is unable to control the second external autonomous driving device to drive along the determined driving path from the external control device and may provide the first external autonomous driving device with the corrected driving path.

The processor may provide the first external autonomous driving device or an external manager device associated with the control device with a notification that it is impossible to drive, when it is determined that the first external autonomous driving device is unable to avoid the second external autonomous driving device and reach the destination.

The processor may determine whether there is a need to manipulate an external facility device, when using the determined driving path, may call an application programming interface (API) for controlling the external facility device, when there is the need to manipulate the external facility device, may receive an API call result from the external facility device, and may determine the corrected driving path based on the API call result.

The processor may determine whether a width of the passage meets a reference width where it is possible for the first external autonomous driving device and the second external autonomous driving device to perform cross driving, based on the information about the plurality of autonomous driving devices and the information associated with the passage, and may transmit a command to decrease a sensor margin of the first external autonomous driving device to a specified rate to the first external autonomous driving device, when the width of the passage does not meet the reference width.

The processor may transmit a command to decrease a driving speed of the first external autonomous driving device to the first external autonomous driving device, when the width of the passage does not meet the reference width.

The processor may receive information about autonomous driving results from the first external autonomous driving device and the second external autonomous driving device through the communication device and may update the cross-driving rule based on the received information.

According to another aspect of the present disclosure, a method for controlling an autonomous driving device in a control device may include receiving a driving path request from a first external autonomous driving device associated with the control device, receiving information associated with a second external autonomous driving device, the information being obtained by the first external autonomous driving device, and information associated with a passage on which the first external autonomous driving device meets with the second external autonomous driving device from the first external autonomous driving device, determining a driving path of the first external autonomous driving device and a driving path of the second external autonomous driving device based on at least a portion of information about a plurality of autonomous driving devices, the information being previously stored, the information associated with the second external autonomous driving device, the information associated with the passage, or a cross-driving rule, providing the first external autonomous driving device and the second external autonomous driving device with the determined driving paths, when it is identified that the second external autonomous driving device is associated with the control device based on the information about the plurality of autonomous driving devices, transmitting a control request for allowing the second external autonomous driving device to drive along the determined driving path to an external control device, when it is identified that the second external autonomous driving device is associated with the external control device, receiving a response to the control request from the external control device, and providing the first external autonomous driving device with the determined driving path or a corrected driving path based on the response to the control request.

The information about the plurality of autonomous driving devices may include at least one of identification information of each of the plurality of autonomous driving devices, manufacturer information of each of the plurality of autonomous driving devices, size information of each of the plurality of autonomous driving devices, information about a sensor configuration included in each of the plurality of autonomous driving devices, or information about a margin of a predetermined sensor.

The cross-driving rule may include a criterion for determining an autonomous driving device to drive along the passage and an autonomous driving device to move to an edge of the passage, based on the information about the passage and the information about the plurality of autonomous driving devices. The providing of the determined driving path or the corrected driving path may include providing the first external autonomous driving device with the determined driving path, when receiving the response indicating that it is able to control the second external autonomous driving device to drive along the determined driving path from the external control device.

The providing of the determined driving path or the corrected driving path may include correcting the driving path such that the first external autonomous driving device is able to avoid the second external autonomous driving device and move to a destination, when receiving the response indicating that it is unable to control the second external autonomous driving device to drive along the determined driving path from the external control device, and providing the first external autonomous driving device with the corrected driving path.

The method may further include providing the first external autonomous driving device or an external manager device associated with the control device with a notification that it is impossible to drive, when it is determined that the first external autonomous driving device is unable to avoid the second external autonomous driving device and reach the destination.

The method may further include determining whether there is a need to manipulate an external facility device, when using the determined driving path, calling an application programming interface (API) for controlling the external facility device, when there is the need to manipulate the external facility device, receiving an API call result from the external facility device, and determining the corrected driving path based on the API call result.

The method may further include determining whether a width of the passage meets a reference width where it is possible for the first external autonomous driving device and the second external autonomous driving device to perform cross driving, based on the information about the plurality of autonomous driving devices and the information associated with the passage, and transmitting a command to decrease a sensor margin of the first external autonomous driving device to a specified rate to the first external autonomous driving device, when the width of the passage does not meet the reference width.

The method may further include transmitting a command to decrease a driving speed of the first external autonomous driving device to the first external autonomous driving device, when the width of the passage does not meet the reference width. The method may further include receiving information

about autonomous driving results from the first external autonomous driving device and the second external autonomous driving device and updating the cross-driving rule based on the received information.

According to one or more aspects of the present disclosure, the control device and the method for controlling the autonomous driving device in the control device may determine a driving path for avoiding an obstacle to reach a destination depending on a driving situation of an autonomous driving device and may provide the autonomous driving device with the driving path.

According to one or more aspects of the present disclosure, the control device and the method for controlling the autonomous driving device in the control device may transmit and receive data with an external control device and may control cross driving between autonomous driving devices managed by the control device and the external control device.

According to one or more aspects of the present disclosure, the control device and the method for controlling the autonomous driving device in the control device may control external structures which are present on a driving path of an external autonomous driving device for driving of the external autonomous driving device.

In addition, various effects ascertained directly or indirectly through the present disclosure may be provided.

Hereinabove, although the present disclosure has been described with reference to exemplary embodiment(s) and the accompanying drawings, the present disclosure is not limited thereto, but may be variously modified and altered by those skilled in the art to which the present disclosure pertains without departing from the spirit and scope of the present disclosure claimed in the following claims.

Therefore, the illustrated features of the present disclosure are provided to explain the spirit and scope of the present disclosure, but not to limit them, so that the spirit and scope of the present disclosure is not limited by the illustrated examples. The scope of the present disclosure should be construed on the basis of the accompanying claims, and all the technical ideas within the scope equivalent to the claims should be e included in the scope of the present disclosure.

What is claimed is:

1. A control device, comprising:
a communication device;
a processor; and
storage storing information about a plurality of autonomous driving devices and a cross-driving rule associated with the plurality of autonomous driving devices,
wherein the processor is configured to:
receive, via the communication device, a driving path request from a first external autonomous driving device associated with the control device;
receive, from the first external autonomous driving device via the communication device, information associated with a second external autonomous driving device and information associated with a passage on which the first external autonomous driving device meets with the second external autonomous driving device;
determine a driving path of the first external autonomous driving device and a driving path of the second external autonomous driving device based on:
at least a portion of the information about the plurality of autonomous driving devices,
the information associated with the second external autonomous driving device,
the information associated with the passage, or
the cross-driving rule;
based on a determination that the second external autonomous driving device is associated with the control device, transmit, to each of the first external autonomous driving device and the second external autonomous driving device, the determined driving paths via the communication device; and
based on a determination that the second external autonomous driving device is associated with an external control device:
transmit, to the external control device via the communication device, a control request for allowing the second external autonomous driving device to drive along the determined driving path of the second external autonomous driving device;
receive, from the external control device via the communication device, a response to the control request; and
transmit, to the first external autonomous driving device and based on the response to the control request, the determined driving path of the first external autonomous driving device or a corrected driving path via the communication device.

2. The control device of claim 1, wherein the information about the plurality of autonomous driving devices comprises at least one of:
identification information of each of the plurality of autonomous driving devices,
manufacturer information of each of the plurality of autonomous driving devices,
size information of each of the plurality of autonomous driving devices,
information about a sensor configuration included in each of the plurality of autonomous driving devices, or
information about a margin of a predetermined sensor.

3. The control device of claim 1, wherein the cross-driving rule comprises:
a criterion for determining, based on the information about the passage and the information about the plurality of autonomous driving devices, an autonomous driving device to drive along the passage and an autonomous driving device to move to an edge of the passage.

4. The control device of claim 1, wherein the processor is configured to:
based on the response indicating that it is able to control the second external autonomous driving device to drive along the determined driving path of the second external autonomous driving device, transmit, to the first external autonomous driving device, the determined driving path of the first external autonomous driving device.

5. The control device of claim 1, wherein the processor is configured to:
based on the response indicating that it is unable to control the second external autonomous driving device to drive along the determined driving path of the second external autonomous driving device:
change the driving path of the first external autonomous driving device such that the first external autonomous driving device is able to avoid a collision with the second external autonomous driving device and move to a destination; and
transmit, to the first external autonomous driving device, the corrected driving path.

6. The control device of claim 5, wherein the processor is configured to:
based on a determination that the first external autonomous driving device is unable to avoid a collision with the second external autonomous driving device to reach the destination, transmit, to the first external autonomous driving device or an external manager device associated with the control device, a notification indicating that a safe driving route is unavailable.

7. The control device of claim 1, wherein the processor is configured to:
determine whether there is a need to manipulate an external facility device, for using the determined driving path of the first external autonomous driving device,
call an application programming interface (API) for controlling the external facility device, based on a determination that there is the need to manipulate the external facility device,
receive an API call result from the external facility device, and
determine the corrected driving path based on the API call result.

8. The control device of claim 1, wherein the processor is configured to:
determine whether a width of the passage satisfies a reference width where it is possible for the first external autonomous driving device to cross paths with the second external autonomous driving device, based on the information about the plurality of autonomous driving devices and the information associated with the passage; and
based on the width of the passage not satisfying the reference width, transmit, to the first external autonomous driving device, a command to decrease a sensor margin of the first external autonomous driving device to a specified rate.

9. The control device of claim 8, wherein the processor is configured to:
based on the width of the passage not satisfying the reference width, transmit, to the first external autonomous driving device, a command to decrease a driving speed of the first external autonomous driving device.

10. The control device of claim 1, wherein the processor is configured to:
receive, from the first external autonomous driving device and the second external autonomous driving device, information about autonomous driving results via the communication device; and
update, based on the received information about autonomous driving results, the cross-driving rule.

11. A method performed by a control device, the method comprising:
receiving a driving path request from a first external autonomous driving device associated with the control device;
receiving, from the first external autonomous driving device, information associated with a second external autonomous driving device and information associated with a passage on which the first external autonomous driving device meets with the second external autonomous driving device;
determining a driving path of the first external autonomous driving device and a driving path of the second external autonomous driving device based on:
at least a portion of information about a plurality of autonomous driving devices,
the information associated with the second external autonomous driving device,
the information associated with the passage, or
a cross-driving rule; and
based on a determination that the second external autonomous driving device is associated with an external control device:
transmitting, to the external control device, a control request for allowing the second external autonomous driving device to drive along the determined driving path of the second external autonomous driving device;
receiving, from the external control device, a response to the control request; and
transmitting, to the first external autonomous driving device and based on the response to the control request, the determined driving path of the first external autonomous driving device or a corrected driving path.

12. The method of claim 11, wherein the information about the plurality of autonomous driving devices comprises at least one of:
identification information of each of the plurality of autonomous driving devices,
manufacturer information of each of the plurality of autonomous driving devices,
size information of each of the plurality of autonomous driving devices,
information about a sensor configuration included in each of the plurality of autonomous driving devices, or
information about a margin of a predetermined sensor.

13. The method of claim 11, wherein the cross-driving rule comprises:
a criterion for determining, based on the information about the passage and the information about the plurality of autonomous driving devices, an autonomous driving device to drive along the passage and an autonomous driving device to move to an edge of the passage.

14. The method of claim 11, wherein the transmitting the determined driving path of the first external autonomous driving device or the corrected driving path comprises:
based on the response indicating that it is able to control the second external autonomous driving device to drive along the determined driving path of the second external autonomous driving device, transmitting, to the first external autonomous driving device, the determined driving path of the first external autonomous driving device.

15. The method of claim 11, wherein the transmitting the determined driving path of the first external autonomous driving device or the corrected driving path comprises:
based on the response indicating that it is unable to control the second external autonomous driving device to drive along the determined driving path of the second external autonomous driving device:
changing the driving path of the first external autonomous such that the first external autonomous driving device is able to avoid a collision with the second external autonomous driving device and move to a destination; and
transmitting, to the first external autonomous driving device, the corrected driving path.

16. The method of claim 15, further comprising:
based on a determination that the first external autonomous driving device is unable to avoid a collision with the second external autonomous driving device to reach the destination, transmitting, to the first external autonomous driving device or an external manager device associated with the control device, a notification indicating that a safe driving route is unavailable.

17. The method of claim 11, further comprising:
determining whether there is a need to manipulate an external facility device, for using the determined driving path of the first external autonomous driving device;
calling an application programming interface (API) for controlling the external facility device, based on a determination that there is the need to manipulate the external facility device;
receiving an API call result from the external facility device; and
determining the corrected driving path based on the API call result.

18. The method of claim 11, further comprising:
determining whether a width of the passage satisfies a reference width where it is possible for the first external autonomous driving device to cross paths with the second external autonomous driving device, based on the information about the plurality of autonomous driving devices and the information associated with the passage; and
based on the width of the passage not satisfying the reference width, transmitting, to the first external autonomous driving device, a command to decrease a sensor margin of the first external autonomous driving device to a specified rate.

19. The method of claim 18, further comprising:
based on the width of the passage not satisfying the reference width, transmitting, to the first external autonomous driving device, a command to decrease a driving speed of the first external autonomous driving device.

20. The method of claim 11, further comprising:
receiving, from the first external autonomous driving device and the second external autonomous driving device, information about autonomous driving results; and
updating, based on the received information about autonomous driving results, the cross-driving rule.
